(19) United States
(12) Patent Application Publication
(10) Pub. No.: US 2024/0270925 A1
(43) Pub. Date: Aug. 15, 2024

(54) GRADIENT CROSS-LINKED POLYMER WITH TRIGGERABLE DECOMPOSITION INTO BENIGN BYPRODUCTS AND METHODS OF USING THE SAME

(71) Applicant: University of Pittsburgh - Of the Commonwealth System of Higher Education, Pittsburgh, PA (US)

(72) Inventors: Andrew E. ASHMAR, Pittsburgh, PA (US); Eric J. BECKMAN, Pittsburgh, PA (US); Susan K. FULLERTON SHIREY, Sarver, PA (US); Jonathan Bingaman, Birdsboro, PA (US); Samantha BUNKE, Newtown, PA (US)

(73) Assignee: University of Pittsburgh - Of the Commonwealth System of Higher Education, Pittsburgh, PA (US)

(21) Appl. No.: 18/290,705

(22) PCT Filed: Jul. 22, 2022
(86) PCT No.: PCT/US2022/038001

§ 371 Date: Jan. 19, 2024

Related U.S. Application Data
(60) Provisional application No. 63/224,994, filed on Jul. 23, 2021.

(51) Int. Cl. C08J 11/14; C08J 3/24

(52) U.S. Cl. CPC C08J 11/14; C08J 3/244; C08J 2300/14

(57) ABSTRACT

An article comprising water-soluble polymer with a cross-link density gradient there through is provided along with methods of forming and using the same. Also provided is a method of recycling the article.

### CROSS-REFERENCE TO RELATED APPLICATIONS

This application claims the benefit of priority to U.S. Provisional Patent Application Ser. No. 63/224,994, filed on Jul. 23, 2021, the entire disclosure of which is hereby incorporated by reference in its entirety.

### BACKGROUND

Over 140 million tons of plastic enters the waste stream every year across the globe. Of this total, approximately 10 million tons of plastic enters the oceans (Jambeck et al., 2015). By 2050, it is estimated that the weight of plastics in the ocean will be greater than that of the fish. A significant portion of this synthetic material finds its way into the environment due to poor waste collection infrastructure in Southeast Asia, but also due to human carelessness. The primary polymers in use (more than 90% of current production) are polyethylene (high density, low density, linear low density), polypropylene, polyvinyl chloride, polyethylene terephthalate (PET), and polyurethane. These polymers are all hydrophobic, non-degradable thermoplastics whose lifetime in the ocean is numbered in decades to centuries. These plastics do not biodegrade; instead, they form micro-particles through abrasive attrition via wave and wind action which subsequently enter the food chain through consumption by birds, fish, and mammals (Foley et al., 2018). Humans also undergo significant exposure to plastic micro-particles, although long-term health impacts are currently unknown (Lehner et al., 2019). Overall, the damage to the ecosystem and human health through improper disposal of plastics is growing at an accelerating rate. Because material solutions to the problem are currently unavailable, cities and states have resorted to banning certain single-use products such as plastic bags and drinking straws (Brooks, 2018), while China and India have banned importation of waste plastics.

In the past, researchers and companies have proposed degradable plastics as the solution to the problem of improper plastic waste disposal, most notably aliphatic polyesters such as polylactic acid (and its copolymers with glycolic acid) and polyhydroxyalkanoates. These polymers can be used to generate plastic articles from fabrics to utensils to containers, but decades of work have shown that they do not degrade under typical environmental conditions, but must instead be placed within an industrial composter to create the conditions necessary for bio-degradation (Karamanlioglu, 2017). Naturally-derived materials such as modified starches (and other polysaccharides) have also been proposed to be used because they readily degrade in the environment; however, they are too hydrophilic to be employed in consumer articles (for example, they would swell in the presence of high humidity and would deform if wet). While degradable, these modified polysaccharides are not viable candidates for packaging and other single-use consumer products.

Thus, there remains a need for biodegradable materials as an alternative to conventional synthetic polymers. The present disclosure satisfies this need.

### SUMMARY OF THE INVENTION

In one aspect, provided is an article comprising a cross-linked polysaccharide or other water-soluble polymer, an outer surface, and an interior. The article comprises a cross-link density gradient along a vector from the outer surface to the interior of the article.

The present disclosure also provides a composition comprising cross-linked polysaccharide or other water-soluble polymer, an outer surface, and an interior, wherein the article comprises a cross-link density gradient along a vector from the outer surface to the interior of the article.

In some embodiments, the article or composition comprises a decreasing cross-link density along the vector. In some embodiments, the cross-links comprise an organic or inorganic substance, or a combination thereof. In some embodiments, the cross-links comprise ionic cross-links and/or photosensitive moieties. In some embodiments, the cross-links comprise ionic cross-links that include one or more of Ca²⁺, Co²⁺, Zn²⁺, Cu²⁺, Mg²⁺, Ag²⁺, Ni²⁺, Ba²⁺, Pb²⁺, Sr²⁺, Cd²⁺, Fe²⁺, Fe³⁺, Mn⁺⁴, and V⁺⁵.

In some embodiments, the cross-links comprise ionic cross-linked formed by an organic compound comprising two or more amine groups. In some embodiments, the cross-links comprise a multi-functional amine, wherein a multifunctional amine is defined as a cross-linker having a number of amine groups per molecule which is greater than or equal to two, and wherein the amine is defined as NR₁R₂R₃, wherein each R can be H or another organic functional group.

In some embodiments, the cross-link density gradient decreases along the vector about 10% or more, such as about 10% to about 20%, about 20% to about 30%, about 30% to about 40%, about 40% to about 50%, about 50% to about 60%, about 60% to about 70%, about 70% to about 80%, or about 80% to about 90%, or about 90% to about 95% of the cross-link density that is at the outer surface, as compared to the cross-link density at a point in the interior on the vector.

In some embodiments, the cross-link density decreases along the vector from a point closer to the outer surface of the article, to a point in the interior and on the vector. In some embodiments, the cross-link density at the point in the interior and on the vector has a cross-link density that is about 1% to about 20%, about 20% to about 40%, about 40% to about 60%, about 60% to about 80%, or about 80% to about 99% of the cross-link density at the point closer to the outer surface of the article.

In some embodiments, the article further comprises one or more additives selected from the group consisting of water, glycerol, propane diol, and glycol ethers.

In some embodiments, the article comprises a wrapper, container, bottle, a bag such as but not limited to a single-use bag, straw, bottle cap, eating utensil, plate, bowl, cup, an article of packaging, film and sheeting, packing materials, trash bags, kitchenware, bottle stopper or screw lid, shopping bags, toiletries containing microbeads, personal care products such as hairbrush and toothbrush, writing utensils, countertops, carpeting and rugs, traffic cones, medical components, outdoor furniture, toys, luggage, car parts, construction materials, cell phone case, or a clothing or shoe item.

In another aspect, a method of forming a cross-link density gradient in an article comprising cross-linked polysaccharide or other water-soluble polymer, an outer surface, and an interior, is provided. The method comprises contacting the article with a solution comprising a cross-linker or irradiating the article. In some embodiments, the cross-links comprise an organic or inorganic compound. Further, the cross-links can comprise ionic cross-links and the cross-linker can comprise one or more of Ca²⁺, Co²⁺, Zn²⁺, Cu²⁺, Mg²⁺, Ag²⁺, Ni²⁺, Ba²⁺, Pb²⁺, Sr²⁺, Cd²⁺, Fe²⁺, Fe³⁺, Mn⁺⁴, and V⁺⁵. In some embodiments, the cross-link density gradient decreases along a vector from the outer surface of the article to the interior of the article.

In some embodiments, the cross-links comprise ionic cross-links formed by an organic compound comprising two or more amine groups. In other embodiments, the cross-links comprise a multi-functional amine, wherein a multifunctional amine is defined as a cross-linker having a number of amine groups per molecule which is greater than or equal to two, and wherein the amine is defined as NR₁R₂R₃, wherein each R can be H or another organic functional group.

In some embodiments, the article comprising cross-linked water-soluble polymer is about 1% to about 20%, about 20% to about 40%, about 40% to about 60%, about 60% to about 80%, or about 80% to about 99% cross-linked before contacting the article with the solution.

In some embodiments, contacting comprises submersion of the article in the solution. In some embodiments, contacting comprises diffusing the solution along the vector from the outer surface to the interior. In some embodiments, contacting comprises spraying the article with the solution. In some embodiments, contacting comprises injecting the article with the solution.

In some embodiments, contacting is for about 2.5 sec or more, about 2.5 sec to about 7.5 sec, about 10 sec to about 30 sec, about 30 sec to about 1 min, about 1 min to about 2.5 min, about 2.5 min to about 5 min, about 5 min to about 30 min, about 30 min to about 1 hr, about 1 hr to about 2 hr, about 2 hr to about 3 hr, about 3 hr to about 4 hr, about 4 hr to about 5 hr, about 5 hr to about 6 hr, about 6 hr to about 8 hr, about 8 hr to about 16 hr, or greater than about 16 hr. In some embodiments, the method further comprises drying the article after the contacting step.

In another aspect, a method of recycling an article comprising cross-linked polysaccharide or other water-soluble polymer, an outer surface, and an interior, is provided, wherein the article comprises a decreasing cross-link density gradient along a vector from the outer surface of the article to the interior. The method comprises decross-linking the cross-linked polysaccharide or other water-soluble polymer.

In some embodiments, the decross-linking initiates at the outer surface of the article and proceeds to the interior. In some embodiments, the decross-linking rate increases along the vector.

In some embodiments, the cross-links comprise an organic or inorganic compound. In some embodiments, the cross-links comprise ionic cross-links. In some embodiments, the ionic cross-links comprise one or more of Ca²⁺, Co²⁺, Zn²⁺, Cu²⁺, Mg²⁺, Ag²⁺, Ni²⁺, Ba²⁺, Pb²⁺, Sr²⁺, Cd²⁺, Fe²⁺, Fe³⁺, Mn⁺⁴, and V⁺⁵. In some embodiments, the cross-links comprise ionic cross-linked formed by an organic compound comprising two or more amine groups. In other embodiments, the cross-links comprise a multi-functional amine, wherein a multifunctional amine is defined as a cross-linker having a number of amine groups per molecule which is greater than or equal to two, and wherein the amine is defined as NR₁R₂R₃, wherein each R can be H or another organic functional group.

In some embodiments, decross-linking comprises contacting the article with a salt solution comprised mostly or substantially of monovalent cations.

In some embodiments, the cross-links comprise photosensitive cross-links. In some embodiments, decross-linking comprises exposing the article to light. In some embodiments, the light comprises UV light or sunlight.

In some embodiments, the decross-linking comprises contacting the article or composition with the solution for about 1 s to about 5 s, about 5 s to about 10 s, about 10 s to about 60 s, about 60 s to about 5 min, about 5 min to about 10 min, about 10 min to about 60 min, about 60 min to about 3 hr, about 3 hr to about 12 hr, about 12 hr to about 24 hr, about 24 hr to about 3 days, or about more than 3 days.

Both the foregoing summary and the following description of the drawings and detailed description are exemplary and explanatory. They are intended to provide further details of the disclosure, but are not to be construed as limiting. Other objects, advantages, and novel features will be readily apparent to those skilled in the art from the following detailed description of the disclosure.

### BRIEF DESCRIPTION OF THE DRAWINGS

FIGS. 1A-1F show evidence of degradation into byproducts in salt water (which may include saline or 5 wt. % NaCl in water). Starting with a 25% cross-linked sodium alginate sample, exposure to the following crosslinkers was evaluated: (FIG. 1A) CaCl₂), (FIG. 1B) CuSO₄, (FIG. 1C) MnCl₂, (FIG. 1D) CoSO₄, (FIG. 1E) NiCl₂, and (FIG. 1F) FeCl₃ at a concentration of 0.045 mol per 100 g DI water for times ranging from 10 to 60 seconds (CaCl₂), CuSO₄, and FeCl₃), 300 to 600 seconds (MnCl₂), 10 to 300 seconds (CoSO₄, NiCl₂). The results show that the method provides gradient cross-linking that is more dense at the surface and less dense at the interior. After exposure for 1 to 4 days in deionized water (DI) water, the materials largely retain their shape. In contrast, the materials degrade catastrophically in 3 to 8 days in salt water (0.085 mol NaCl per 100 g DI water, which is equivalent to 5 wt % NaCl in DI water).

FIGS. 2A, 2B, 2C, and 2D show samples of partially cross-linked sodium alginate treated under various conditions. FIG. 2A shows 5 wt % CaCl₂) in water (left panel) or salt water (right panel) for 5 hours and dried to produce the articles in FIG. 2C. FIG. 2B shows 5 wt % CaCl₂) in water (left panel) or salt water (right panel) for 30 min and dried for 4 days to produce the articles in FIG. 2D.

FIG. 3 shows visual evidence of the cross-linking gradient that is created. In this case, the 25% cross-linked sodium alginate sample is exposed to CuSO₄ for 10 seconds, corresponding to FIG. 1A, CuSO₄. Cu²⁺ turns the cross-linked shell blue, while the less-crosslinked core is a lighter color.

FIG. 4A depicts uncrosslinked alginate film, with little to no wrinkling, and FIG. 4B depicts an alginate film crosslinked with L-Lysine, showing wrinkling because of syneresis.

FIG. 5 depicts vials containing deionized water (left) and saltwater (right) samples after the ninhydrin test, as detailed in Example 5.

FIG. 6 shows a stress vs. strain plot for an uncrosslinked alginate sample and a lysine-crosslinked sample.

FIG. 7 shows dimensions of a dog-bone sample used for tensile tests (all measurements are in millimeters).

FIG. 8 depicts a stress vs. strain curve for crosslinked and uncrosslinked sodium alginate.

FIG. 9 shows diffusion rate of copper (II) sulfate in alginate (R-Sq.=0.874).

FIG. 10 shows ionic diffusion of calcium from alginate films in deionized and salt water.

### DETAILED DESCRIPTION

Disclosed herein is a material that can be employed in applications where a traditional thermoplastic or thermoset might be employed, but also where contact with seawater or light leads to rapid and complete degradation to benign, water-soluble byproducts. The material may be a polysaccharide-based material. The polymer retains its physical properties when wet, but can degrade within a relatively short period of time when it contacts a salt solution comprised mostly of monovalent cations; for example, but not limited to salt water or brine (i.e., water containing salt at typical seawater concentrations and above).

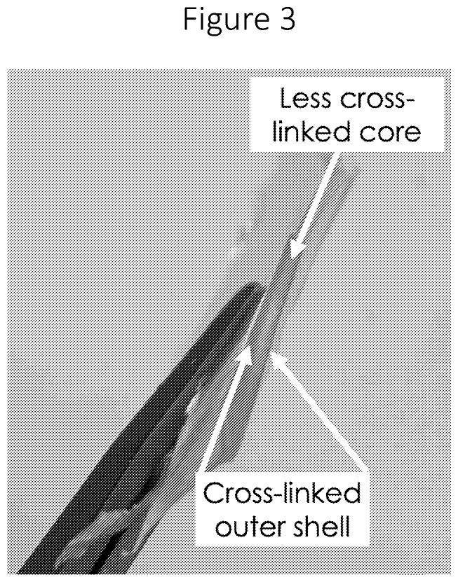

The present disclosure describes and provides materials created with a gradient in reversible ionic and either organic or inorganic (calcium, copper, manganese, iron, nickel, cobalt, barium, strontium, cadmium, lead, etc.) cross-links in a polyalginate, where the highest cross-link density is close to the surface of the material or article. See e.g., FIG. 3. The material can be exposed to water for days without noticeable change to its properties. However, exposure to aqueous NaCl leads to a complete replacement of the calcium cross-links with monovalent sodium, leading to rapid degradation of the polysaccharide and subsequent degradation to benign byproducts. If the material were collected for recycling, exposure to aqueous NaCl would lead to dissolution of the material, which would precipitate (through control of the pH or concentration, or it can also be precipitated using divalent cations), thereby allowing reuse of the polysaccharide.

One of the key innovations described herein is that the material or article manufactured from the material retains its structure under standard-use conditions, but degrades catastrophically to benign fragments when exposed to saline waters. A saltwater-triggered degradation mechanism provides a useful end-of-life disposal solution that addresses a current global problem. Another key innovation is that the cross-link density, and therefore the degradation time, can be fine-tuned, offering the potential for dialing-in a post-use disposal time constant.

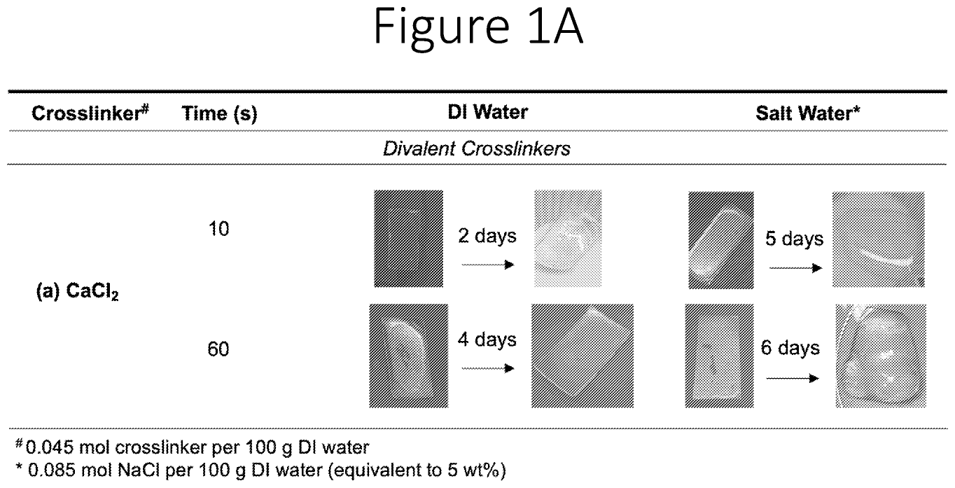

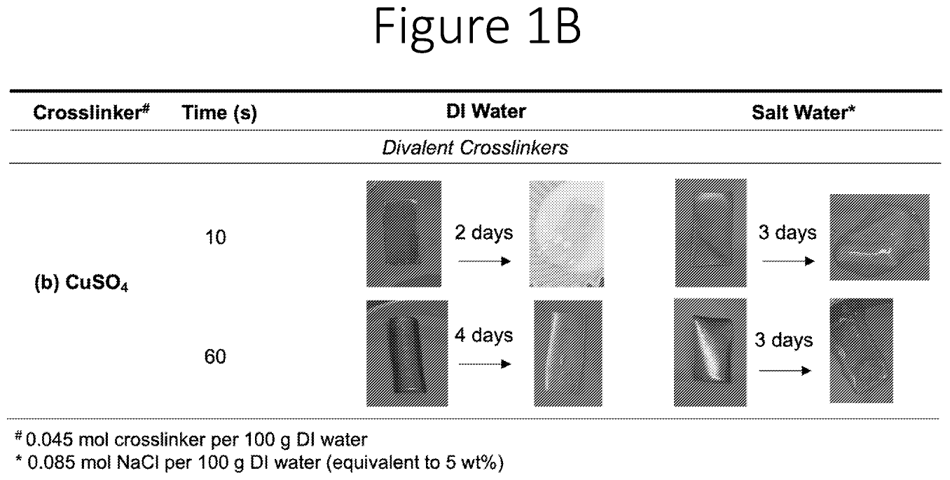

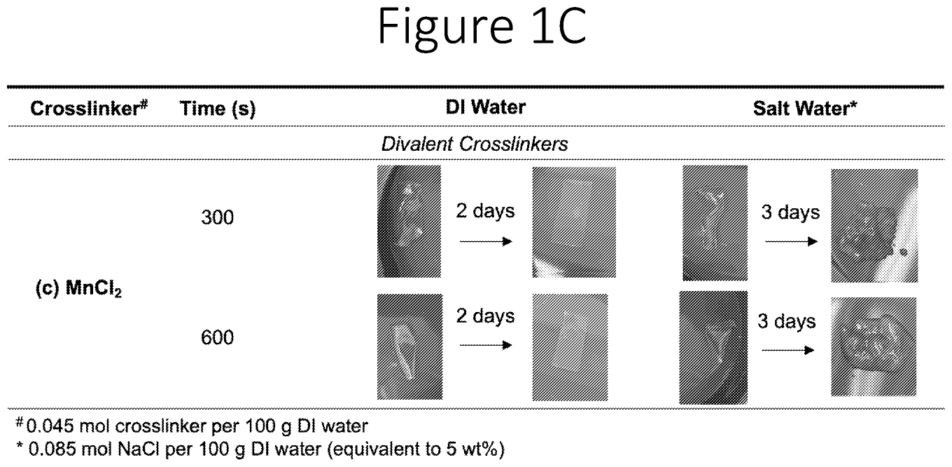

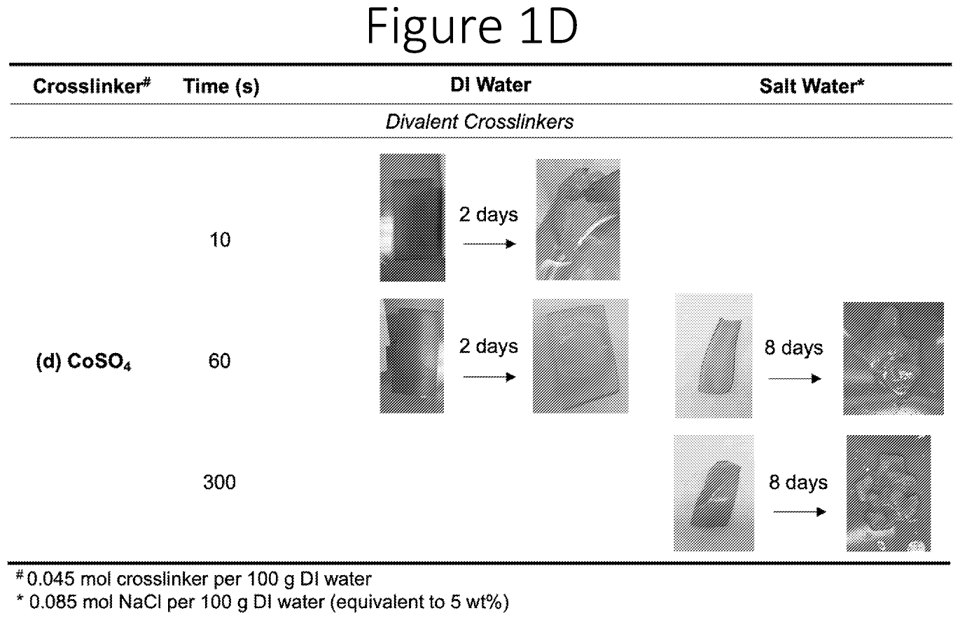

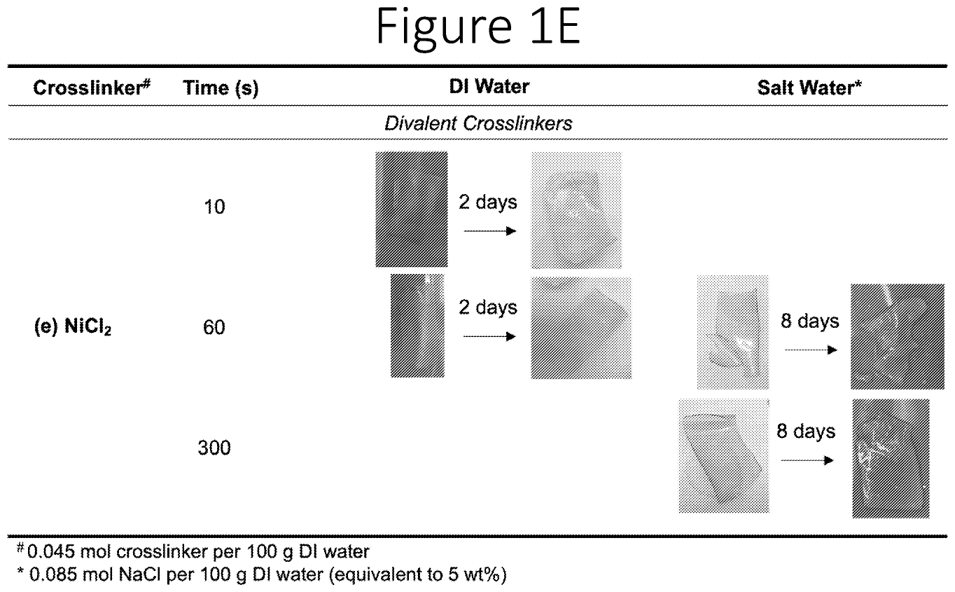

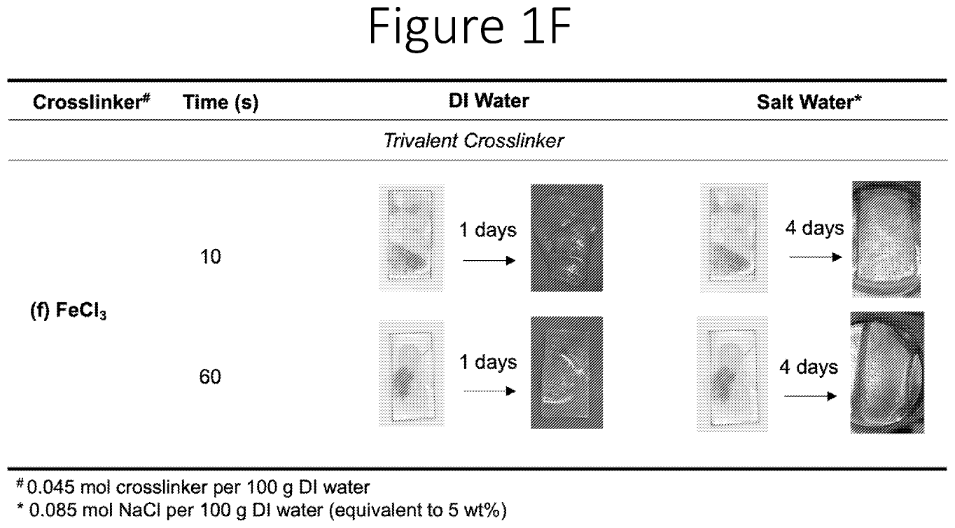

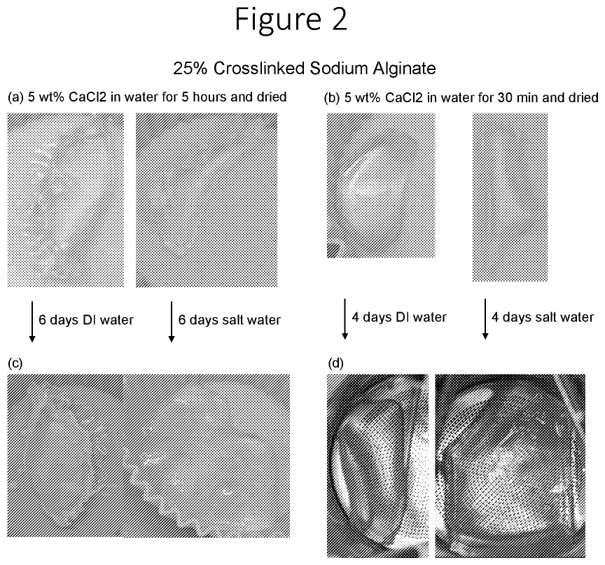

Application of the described technology, both in forming an exemplary plastic (e.g., an alginate or polysaccharide plastic), followed by dissolution of the plastic, is described in detail in the examples below. In particular, Example 1 describes preparation of an initially partially (25%) cross-lined polymer plastic article. For this example, sodium alginate was used as the base material, but other exemplary base materials are described herein. Additional cross-linking of this material is described in Examples 2 and 4, where various different cross-linking solutions were employed (e.g., CaCl₂) (FIGS. 1A, 2A, and 2B), CuSO₄ (FIG. 1), MnCl₂ (FIG. 1C), CoSO₄ (FIG. 1D), NiCl₂ (FIG. 1E), and FeCl₃ (FIG. 1F)). Both divalent and trivalent cross-linkers were utilized in the examples below.

The additional cross-linking process creates a gradient of cross-links via diffusion from the surface of the article or composition to the interior of the article or composition. See e.g., FIG. 3.

Next, as detailed in Examples 3 and 4, the fully cross-linked articles or compositions from Example 2 and 4 were subjected to conditions resulting in dissolution of the cross-linked alginate plastics in conditions mimicking those found in an ocean environment. In particular, as shown in FIGS. 1A-F and 2A-D, plastic made by the methods described herein retained their shape, including sharp or clear edges and/or physical structure, following exposure to deionized water for a prolonged period of time (e.g., 2-6 days).

However, a marked contrast was seen in the stability and lack of structure retention following exposure of the samples to salt water. In particular, FIGS. 1A-1F, 2C, and 2D show physical evidence that the following exposure to salt water, the alginate plastics degrade and demonstrate a significant loss of physical structure, as none of the sides of each of the articles remains clearly defined, and instead resemble a “blob-like” or amorphous structure.

The visual evidence in FIGS. 1A-1F, 2C, and 2D show that the alginate plastic samples exposed to DI water have largely retained their shape, while the alginate plastic samples exposed to salt water have not retained their shape. In particular, the samples exposed to DI water can be manipulated with tweezers and remain free-standing, while those exposed to salt water fall apart when mechanically stressed by tweezers.

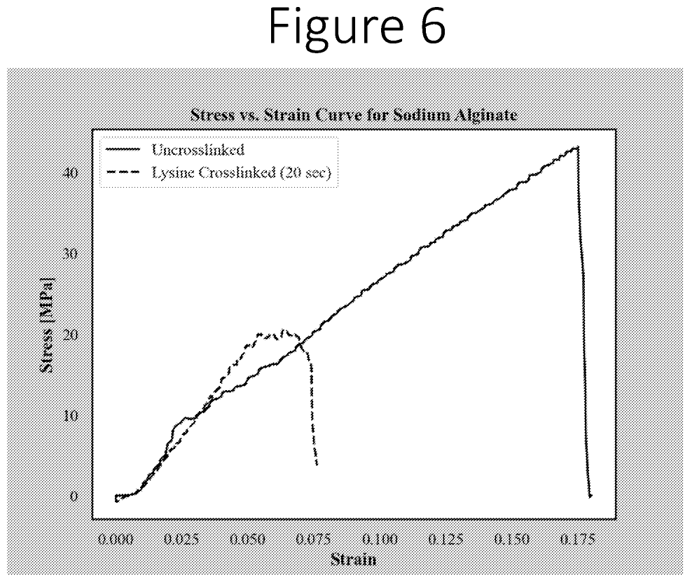

Additional data supporting the present disclosure is detailed in Examples 5-8. In particular, Example 5 details data showing the crosslinking capability of diamines. The experiment details dissolution of an alginate contacted with water, but in contrast an alginate film contacted with a cross-linking L-lysine solution remained intact upon immersion. Further, once dry, the alginate crosslinked with L-lysine appeared to be significantly stronger than the uncrosslinked alginate film. Example 5 also details reversibility of the lysine crosslinking by immersing two identical lysine-crosslinked films in deionized water and salt water. FIG. 5 shows that the lysine-crosslinked sample placed in deionized water retained a slight yellow-orange tint (left vial) (meaning that the crosslinking and structure is retained), while the sample placed in salt water turned a blue-purple color (right vial), indicating that the saltwater triggers decrosslinking of the lysine-crosslinked polymer. Finally, FIG. 6 shows the stress vs. strain plot for an uncrosslinked alginate sample and the lysine-crosslinked sample, indicating that the lysine-crosslinked alginate sample exhibited properties characteristic of a crosslinked polymer.

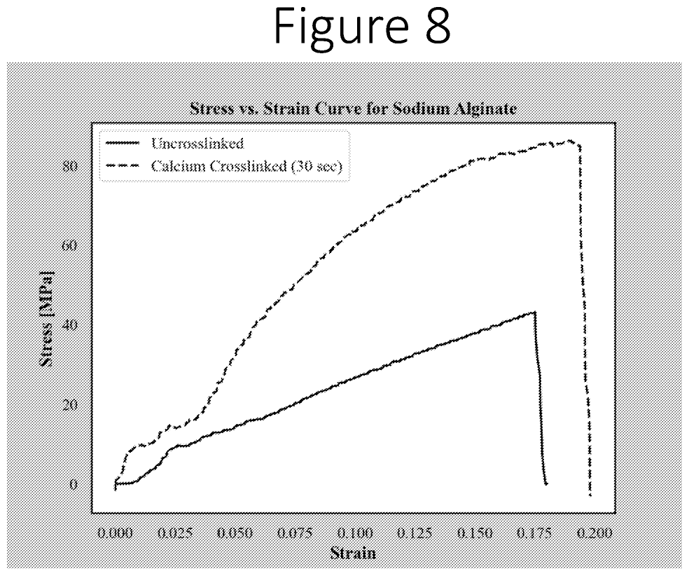

Next, Example 6 details the higher strength of crosslinked samples. The results detailed in the example show that uncrosslinked sodium alginate sample exhibited an ultimate strength of about 250 MPa, while the crosslinked sample exhibited an ultimate strength of about 460 MPa, as shown in FIG. 8. The higher strength of the crosslinked sample proves that the crosslinking is effective, and that higher calcium content corresponds to increased film strength.

Example 7 describes a demonstration of gradient crosslink density. In particular, samples of sodium alginate partially crosslinked with calcium, and then further crosslinked by immersion in a solution of copper (II) sulfate, were used as test articles. The concentration of copper in each crosslinked alginate sample was calculated, and the results confirmed that that the ions diffuse into the material in a gradient fashion.

Finally, Example 8 details the successful dissolution of crosslinked films prepared according to the present disclosure. A sodium alginate film crosslinked with CaCl₂) ware prepared. Samples of the film were then placed in water and salt water for a period of time, followed by an analysis of calcium concentration in the water and salt water media. The resulting data showed that the calcium leaves the alginate film much more readily in salt water compared to deionized water, proving the reversibility of the crosslinks.

These examples demonstrate the successful implementation of developing a plastic that retains its form and shape in water, but which readily degrades when exposed to salt water or conditions that mimic exposure to an ocean.

In one aspect of the disclosure, described are articles or compositions that substantially retain their physical shape following exposure to water, with “substantially” defined as a less than about 10% change in physical structure. Other aspects encompass a less than about 9%, less than about 8%, less than about 7%, less than about 6%, less than about 5%, less than about 4%, less than about 3%, less than about 2%, or a less than about 1% change in physical structure, including but not limited to retaining clearly defined lines, edges, volumes, surfaces areas, masses, and/or faces.

In another aspect of the disclosure, described are articles or compositions that substantially degrade, and/or substantially lose their physical structure when the articles or compositions are exposed to salt water. In one aspect, the articles or compositions exposed to salt water do not retain any clearly defined lines, edges, volumes, surfaces areas, masses, or faces. In another aspect, substantially all of the structure of the article is lost when expose to salt water, including but not limited to failing to retain clearly defined lines, edges, volumes, surfaces areas, masses, and/or faces.

### I. Compositions and Articles

In one aspect, the present disclosure provides an article comprising cross-linked polysaccharide or other water-soluble polymer, an outer surface, and an interior, wherein the article comprises a cross-link density gradient along a vector from the outer surface of the article to the interior of the article.

The present disclosure provides also provides a composition comprising cross-linked polysaccharide or other water-soluble polymer, an outer surface, and an interior, wherein the composition comprises a cross-link density gradient along a vector from the outer surface of the composition to the interior of the composition.

In some embodiments, the cross-linked water-soluble polymer comprises a polysaccharide. In some embodiments, the cross-linked water-soluble polymer comprises chitin, cellulose, starch, dextran, glucan, chitosan, alginate, hyaluronic acid, glycogen, agar, carrageenan, fucoidan, pectin, polygalacturonate, hemicellulose, xylan, arabinan, mannan, or any combination thereof. In some embodiments, the cross-linked water-soluble polymer comprises a hydrogel. In some embodiments, the hydrogel is selected from the group consisting of polyvinyl alcohol, sodium polyacrylate, acrylate polymers, polyAMPS, polyvinylpyrrolidone, polyacrylamide, silicone, agarose, hyaluronan, hydrolyzed polyacrylicnitrile, cross-linked polymers based on hydrophilic derivatives of acrylic or methacrylic acid, cross-linked polymers based on hydrophilic vinylic monomers, or any combination thereof. The polymer may be homopolymeric, heteropolymeric (including, but not limited to, cross-polymers or co-polymers of any co-monomer distribution), and may be linear, branched, hyperbranched, dendrimeric, or cross-linked to any extent. Examples of suitable polymers include, but are not limited to, gelatin, methylcellulose, hydroxyethyl methyl cellulose, hydroxypropyl methyl cellulose, polyethylene oxide, polyacrylamides, polyacrylic acid, polymethacrylic acid, salts of polyacrylic acid, salts of polymethacrylic acid, poly(2-hydroxyethyl methacrylate), polylactic acid, polyglycolic acid, polyvinylalcohol, polyanhydrides such as poly(methacrylic) anhydride, poly(acrylic) anhydride, polysebasic anhydride, collagen, poly(hyaluronic acid), hyaluronic acid-containing polymers and copolymers, polypeptides, dextran, dextran sulfate, chitosan, chitin, agarose gels, fibrin gels, soy-derived hydrogels and alginate-based hydrogels such as poly(sodium alginate), and combinations thereof.

In some embodiments, the outer surface of the article or composition comprises the surface area of the article or composition. In some embodiments, the outer surface comprises a layer of the composition or article comprising the outer surface area and having a thickness which extends to the interior of the composition or article. In some embodiments, the interior comprises a volume within the surface area of the article or composition.

In some embodiments, the volume of the interior of the article or composition is about 1%, about 2%, about 3%, about 4%, about 5%, about 6%, about 7%, about 8%, about 9%, about 10%, about 20%, about 30%, about 40%, about 50%, about 60%, about 70%, about 80%, about 90%, about 95%, or about 99% of the volume defined by the volume inside of the outer surface area of the article or composition, or a range defined by any two of the recited values above (e.g., about 2% to about 60%), or a subrange therewithin such a range (e.g., about 15% to about 35%, etc.).

In some embodiments, the interior is about 0.001, about 0.005, about 0.01, about 0.02, about 0.03, about 0.04, about 0.05, about 0.06, about 0.07, about 0.08, about 0.09, about 0.1, about 0.2, about 0.3, about 0.4, about 0.5, about 0.6, about 0.7, about 0.8, about 0.9, about 1, about 1.1, about 1.2, about 1.3, about 1.4, about 1.5, about 1.6, about 1.7, about 1.8, about 1.9, about 2, about 2.1, about 2.2, about 2.3, about 2.4, about 2.5, about 2.6, about 2.7, about 2.8, about 2.9, about 3, about 3.1, about 3.2, about 3.3, about 3.4, about 3.5, about 3.6, about 3.7, about 3.8, about 3.9, about 4, about 4.1, about 4.2, about 4.3, about 4.4, about 4.5, about 4.6, about 4.7, about 4.8, about 4.9, about 5, about 5.1, about 5.2, about 5.3, about 5.4, about 5.5, about 5.6, about 5.7, about 5.8, about 5.9, or about 6 mm from the outer surface of the article or composition, or a range defined by any two of the above recited values (e.g., about 1.1 to about 5.2 mm), or a subrange therewithin such a range (e.g, about 1.3 to about 2.4 mm). These recited lengths and ranges may be measured from any point on the outer surface to any point on or within the interior.

In some embodiments, the interior is about 0.001, about 0.005, about 0.01, about 0.02, about 0.03, about 0.04, about 0.05, about 0.06, about 0.07, about 0.08, about 0.09, about 0.1, about 0.2, about 0.3, about 0.4, about 0.5, about 0.6, about 0.7, about 0.8, about 0.9, about 1, about 1.1, about 1.2, about 1.3, about 1.4, about 1.5, about 1.6, about 1.7, about 1.8, about 1.9, about 2, about 2.1, about 2.2, about 2.3, about 2.4, about 2.5, about 2.6, about 2.7, about 2.8, about 2.9, about 3, about 3.1, about 3.2, about 3.3, about 3.4, about 3.5, about 3.6, about 3.7, about 3.8, about 3.9, about 4, about 4.1, about 4.2, about 4.3, about 4.4, about 4.5, about 4.6, about 4.7, about 4.8, about 4.9, about 5, about 5.1, about 5.2, about 5.3, about 5.4, about 5.5, about 5.6, about 5.7, about 5.8, about 5.9, or about 6 cm from the outer surface of the article or composition, or a range defined by any two of the above recited values (e.g., about 1 to about 5 cm), or a subrange therewithin such a range (e.g., about 1.2 to about 4.8 cm). These recited lengths and ranges may be measured from any point on the outer surface to any point on or within the interior.

In some embodiments, the interior is about 10, about 50, about 1, about 2, about 3, about 4, about 5, about 6, about 7, about 8, about 9, about 10, about 20, about 30, about 40, about 50, about 60, about 70, about 80, about 90, about 100, about 110, about 120, about 130, about 140, about 150, about 160, about 170, about 180, about 190, about 200, about 210, about 220, about 230, about 240, about 250, about 260, about 270, about 280, about 290, about 300, about 310, about 320, about 330, about 340, about 350, about 360, about 370, about 380, about 390, about 400, about 410, about 420, about 430, about 440, about 450, about 460, about 470, about 480, about 490, about 500, about 510, about 520, about 530, about 540, about 550, about 560, about 570, about 580, about 590, or about 600 mm from the outer surface of the article or composition, or a range defined by any two of the above recited values (e.g., about 90 to about 500 mm), or a subrange therewithin such a range (e.g., about 95 to about 450 mm). These recited lengths and ranges may be measured from any point on the outer surface to any point on or within the interior.

In some embodiments, the thickness of the outer surface is about 0.001, about 0.005, about 0.01, about 0.02, about 0.03, about 0.04, about 0.05, about 0.06, about 0.07, about 0.08, about 0.09, about 0.1, about 0.2, about 0.3, about 0.4, about 0.5, about 0.6, about 0.7, about 0.8, about 0.9, about 1, about 1.1, about 1.2, about 1.3, about 1.4, about 1.5, about 1.6, about 1.7, about 1.8, about 1.9, about 2, about 2.1, about 2.2, about 2.3, about 2.4, about 2.5, about 2.6, about 2.7, about 2.8, about 2.9, about 3, about 3.1, about 3.2, about 3.3, about 3.4, about 3.5, about 3.6, about 3.7, about 3.8, about 3.9, about 4, about 4.1, about 4.2, about 4.3, about 4.4, about 4.5, about 4.6, about 4.7, about 4.8, about 4.9, about 5, about 5.1, about 5.2, about 5.3, about 5.4, about 5.5, about 5.6, about 5.7, about 5.8, about 5.9, or about 6 mm, or a range defined by any two of the above recited values (e.g., about 1.7 to about 4.9 mm), or a subrange therewithin such a range (e.g., about 1.9 to about 4.1 mm).

In some embodiments, the thickness of the outer surface of the article or composition is about 0.001, about 0.005, about 0.01, about 0.02, about 0.03, about 0.04, about 0.05, about 0.06, about 0.07, about 0.08, about 0.09, about 0.1, about 0.2, about 0.3, about 0.4, about 0.5, about 0.6, about 0.7, about 0.8, about 0.9, about 1, about 1.1, about 1.2, about 1.3, about 1.4, about 1.5, about 1.6, about 1.7, about 1.8, about 1.9, about 2, about 2.1, about 2.2, about 2.3, about 2.4, about 2.5, about 2.6, about 2.7, about 2.8, about 2.9, about 3, about 3.1, about 3.2, about 3.3, about 3.4, about 3.5, about 3.6, about 3.7, about 3.8, about 3.9, about 4, about 4.1, about 4.2, about 4.3, about 4.4, about 4.5, about 4.6, about 4.7, about 4.8, about 4.9, about 5, about 5.1, about 5.2, about 5.3, about 5.4, about 5.5, about 5.6, about 5.7, about 5.8, about 5.9, or about 6 cm, or a range defined by any two of the above recited values (e.g., about 0.5 to about 4.2 cm), or a subrange therewithin such a range (e.g., about 0.9 to about 4 cm).

In some embodiments, the thickness of the outer surface of the article or composition is about 10, about 50, about 1, about 2, about 3, about 4, about 5, about 6, about 7, about 8, about 9, about 10, about 20, about 30, about 40, about 50, about 60, about 70, about 80, about 90, about 100, about 110, about 120, about 130, about 140, about 150, about 160, about 170, about 180, about 190, about 200, about 210, about 220, about 230, about 240, about 250, about 260, about 270, about 280, about 290, about 300, about 310, about 320, about 330, about 340, about 350, about 360, about 370, about 380, about 390, about 400, about 410, about 420, about 430, about 440, about 450, about 460, about 470, about 480, about 490, about 500, about 510, about 520, about 530, about 540, about 550, about 560, about 570, about 580, about 590, or about 600 mm, or a range defined by any two of the above recited values (e.g., about 150 to about 400 mm), or a subrange therewithin such a range (e.g., about 160 to about 375 mm).

In some embodiments, the vector is perpendicular to the outer surface area of the article or composition. In some embodiments, the vector runs along a point on the outer surface of the article or composition to a point in the interior. In some embodiments, the vector is about 0.001, about 0.005, about 0.01, about 0.02, about 0.03, about 0.04, about 0.05, about 0.06, about 0.07, about 0.08, about 0.09, about 0.1, about 0.2, about 0.3, about 0.4, about 0.5, about 0.6, about 0.7, about 0.8, about 0.9, about 1, about 1.1, about 1.2, about 1.3, about 1.4, about 1.5, about 1.6, about 1.7, about 1.8, about 1.9, about 2, about 2.1, about 2.2, about 2.3, about 2.4, about 2.5, about 2.6, about 2.7, about 2.8, about 2.9, about 3, about 3.1, about 3.2, about 3.3, about 3.4, about 3.5, about 3.6, about 3.7, about 3.8, about 3.9, about 4, about 4.1, about 4.2, about 4.3, about 4.4, about 4.5, about 4.6, about 4.7, about 4.8, about 4.9, about 5, about 5.1, about 5.2, about 5.3, about 5.4, about 5.5, about 5.6, about 5.7, about 5.8, about 5.9, or about 6 mm from a point on the outer surface of the article or composition to a point in the interior of the article or composition, or a range defined by any two of the above recited values (e.g., about 1.9 to about 5.5 mm), or a subrange therewithin such a range (e.g., about 2.1 to about 4.8 mm).

In some embodiments, the interior is about 0.001, about 0.005, about 0.01, about 0.02, about 0.03, about 0.04, about 0.05, about 0.06, about 0.07, about 0.08, about 0.09, about 0.1, about 0.2, about 0.3, about 0.4, about 0.5, about 0.6, about 0.7, about 0.8, about 0.9, about 1, about 1.1, about 1.2, about 1.3, about 1.4, about 1.5, about 1.6, about 1.7, about 1.8, about 1.9, about 2, about 2.1, about 2.2, about 2.3, about 2.4, about 2.5, about 2.6, about 2.7, about 2.8, about 2.9, about 3, about 3.1, about 3.2, about 3.3, about 3.4, about 3.5, about 3.6, about 3.7, about 3.8, about 3.9, about 4, about 4.1, about 4.2, about 4.3, about 4.4, about 4.5, about 4.6, about 4.7, about 4.8, about 4.9, about 5, about 5.1, about 5.2, about 5.3, about 5.4, about 5.5, about 5.6, about 5.7, about 5.8, about 5.9, or about 6 cm from a point on the outer surface of the article or composition to a point in the interior of the article or composition, or a range defined by any two of the above recited values (e.g., about 2.4 to about 5.2 cm), or a subrange therewithin such a range (e.g., about 2.5 to about 4.8 cm).

In some embodiments, the vector is about 1, about 2, about 3, about 4, about 5, about 6, about 7, about 8, about 9, about 10, about 20, about 30, about 40, about 50, about 60, about 70, about 80, about 90, about 100, about 110, about 120, about 130, about 140, about 150, about 160, about 170, about 180, about 190, about 200, about 210, about 220, about 230, about 240, about 250, about 260, about 270, about 280, about 290, about 300, about 310, about 320, about 330, about 340, about 350, about 360, about 370, about 380, about 390, about 400, about 410, about 420, about 430, about 440, about 450, about 460, about 470, about 480, about 490, about 500, about 510, about 520, about 530, about 540, about 550, about 560, about 570, about 580, about 590, or about 600 mm, or a range defined by any two of the above recited values (e.g., about 90 to about 150 mm), or a subrange therewithin such a range (e.g., about 100 to about 135 mm).

In some embodiments, the article or composition comprises a decreasing cross-link density along the vector. In some embodiments, the cross-link density decreases by about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, or about 100% along the vector, or a range defined by any two of the above recited values (e.g., about 20% to about 65%), or a subrange therewithin such a range (e.g., about 25% to about 52%).

In some embodiments, the cross-link density gradient decreases along the vector to about 10% or more, about 10% to about 20%, about 20% to about 30%, about 30% to about 40%, about 40% to about 50%, about 50% to about 60%, about 60% to about 70%, about 70% to about 80%, or about 80% to about 90% or about 90% to about 95% of the cross-link density at the outer surface of the article or composition, at a point in the interior on the vector, or a range defined by any two of the above recited values (e.g., about 20% to about 60%), or a subrange therewithin such a range (e.g., about 25% to about 55%).

In some embodiments, the average cross link density at one or more of any of the aforementioned points (or a spherical or cubic volume around such a point of about 0.001, about 0.005, about 0.01, about 0.02, about 0.03, about 0.04, about 0.05, about 0.06, about 0.07, about 0.08, about 0.09, about 0.1, about 0.2, about 0.3, about 0.4, about 0.5, about 0.6, about 0.7, about 0.8, about 0.9, about 1, about 1.1, about 1.2, about 1.3, about 1.4, about 1.5, about 1.6, about 1.7, about 1.8, about 1.9, about 2, about 2.1, about 2.2, about 2.3, about 2.4, about 2.5, about 2.6, about 2.7, about 2.8, about 2.9, about 3, about 3.1, about 3.2, about 3.3, about 3.4, about 3.5, about 3.6, about 3.7, about 3.8, about 3.9, about 4, about 4.1, about 4.2, about 4.3, about 4.4, about 4.5, about 4.6, about 4.7, about 4.8, about 4.9, about 5, about 5.1, about 5.2, about 5.3, about 5.4, about 5.5, about 5.6, about 5.7, about 5.8, about 5.9, about 6, about 7, about 8, about 9, about 10, about 20, about 30, about 40, about 50, about 60, about 70, about 80, about 90, about 100, about 110, about 120, about 130, about 140, about 150, about 160, about 170, about 180, about 190, about 200, about 210, about 220, about 230, about 240, about 250, about 260, about 270, about 280, about 290, about 300, about 310, about 320, about 330, about 340, about 350, about 360, about 370, about 380, about 390, about 400, about 410, about 420, about 430, about 440, about 450, about 460, about 470, about 480, about 490, about 500, about 510, about 520, about 530, about 540, about 550, about 560, about 570, about 580, about 590, or about 600 μm³, mm³, cm³, dm³); or the average cross link density at the outer surface of the article or composition, comprises about 0.001, about 0.005, about 0.01, about 0.02, about 0.03, about 0.04, about 0.05, about 0.06, about 0.07, about 0.08, about 0.09, about 0.1, about 0.2, about 0.3, about 0.4, about 0.5, about 0.6, about 0.7, about 0.8, about 0.9, about 1, about 1.1, about 1.2, about 1.3, about 1.4, about 1.5, about 1.6, about 1.7, about 1.8, about 1.9, about 2, about 2.1, about 2.2, about 2.3, about 2.4, about 2.5, about 2.6, about 2.7, about 2.8, about 2.9, about 3, about 3.1, about 3.2, about 3.3, about 3.4, about 3.5, about 3.6, about 3.7, about 3.8, about 3.9, about 4, about 4.1, about 4.2, about 4.3, about 4.4, about 4.5, about 4.6, about 4.7, about 4.8, about 4.9, about 5, about 5.1, about 5.2, about 5.3, about 5.4, about 5.5, about 5.6, about 5.7, about 5.8, about 5.9, about 6, about 7, about 8, about 9, about 10, about 20, about 30, about 40, about 50, about 60, about 70, about 80, about 90, about 100, about 110, about 120, about 130, about 140, about 150, about 160, about 170, about 180, about 190, about 200, about 210, about 220, about 230, about 240, about 250, about 260, about 270, about 280, about 290, about 300, about 310, about 320, about 330, about 340, about 350, about 360, about 370, about 380, about 390, about 400, about 410, about 420, about 430, about 440, about 450, about 460, about 470, about 480, about 490, about 500, about 510, about 520, about 530, about 540, about 550, about 560, about 570, about 580, about 590, or about 600 moles, mmol, or micromoles of cation per μm³, mm³, cm³, or dm³ of article, or a range defined by any two of the above recited values (e.g., about 90 to about 150 mmol), or a subrange therewithin such a range (e.g., about 100 to about 135 mmol).

In some embodiments, the cross-links comprise one or more organic or inorganic compounds. In some embodiments, the cross-links comprise ionic cross-links. In some embodiments the ionic-cross link comprises an ion or combination of different ions. In some embodiments, the cross-links comprise one or more of Ca²⁺, Co²⁺, Zn²⁺, Cu²⁺, Mg²⁺, Ag²⁺, Ni²⁺, Ba²⁺, Pb²⁺, Sr²⁺, Cd²⁺, Fe²⁺, Fe³⁺, Mn⁺⁴, V⁺⁵, or any combination thereof.

In some embodiments, the cross-links comprise photosensitive moieties. In some embodiments, the cross-links comprise covalent bonds. In some embodiments, the cross-links comprise aryl or heteroaryl groups. In some embodiments, the covalent bonds, aryl or heteroaryl groups are formed during cross-linking or exposure to light.

In some embodiments, the article or composition comprises one or more additives, and the additives may be added to the cross-linked water-soluble polymer before formation of the article or composition. Without limitation, examples of such optional additional components include surfactants; emulsifiers; dispersants; rheology modifiers such as thickeners; density modifiers; aziridine stabilizers; polymers; diluents; acid acceptors; antioxidants; heat stabilizers; flame retardants; foam stabilizers; solvents; diluents; plasticizers; fillers and inorganic particles, pigments, dyes desiccants solvents, powders, coloring agents, thickeners, waxes, stabilizing agents, pH regulators, and silicones. In some embodiments, the additives may include water, glycerol, propane diol, and glycol ethers.

Thickening agents may optionally be added to cross-linked polysaccharide or other water-soluble polymer of the article or composition to provide a convenient viscosity. For example, viscosities within the range of about 500 to about 25,000 mm²/s at 25° C. or more, alternatively in the range of about 3,000 to about 7,000 mm²/s at 25° C., are usually suitable. Suitable thickening agents are exemplified by sodium alginate; gum arabic; polyoxyethylene; guar gum; hydroxypropyl guar gum; ethoxylated alcohols, such as laureth-4 or polyethylene glycol 400; cellulose derivatives exemplified by methylcellulose, methylhydroxypropylcellulose, hydroxypropylcellulose, polypropylhydroxyethylcellulose; starch and starch derivatives exemplified by hydroxyethylamylose and starch amylose; locust bean gum; electrolytes exemplified by sodium chloride and ammonium chloride; saccharides such as fructose and glucose; and derivatives of saccharides such as PEG-120, methyl glucose dilate; or mixtures of two or more of these. Alternatively, the thickening agent can be selected from, for example, cellulose derivatives, saccharide derivatives, and electrolytes, or from a combination of two or more of the above thickening agents exemplified by a combination of a cellulose derivative and any electrolyte, and a starch derivative and any electrolyte. The thickening agent may be present in an amount from about 0.05 to about 10 wt %; alternatively from about 0.05 to about 5 wt %, based on the total weight of the article or composition. Thickeners based on acrylate derivatives, such as polyacrylate crosspolymer, Acrylates/C1030 Alkyl Acrylate crosspolymer, polyacrylamide derivatives, sodium polyacrylate may also be added.

Other optional additives can include powders and pigments. A powder composition can be generally defined as dry, particulate matter having a particle size of about 0.02-about 50 microns. The particulate matter may be colored or non-colored (for example white). Suitable powders include, but are not limited to, bismuth oxychloride, titanated mica, fumed silica, spherical silica beads, polymethylmethacrylate beads, boron nitride, aluminum silicate, aluminum starch octenylsuccinate, bentonite, kaolin, magnesium aluminum silicate, silica, silica silylate, talc, mica, titanium dioxide, nylon, silk powder. The above-mentioned powders may be surface treated to render the particles hydrophobic in nature. The powder also comprises various organic and inorganic pigments. The organic pigments are generally various aromatic types including azo, indigoid, triphenylmethane, anthraquinone, and xanthine dyes which are designated as D&C and FD&C blues, browns, greens, oranges, reds, yellows, etc. Inorganic pigments generally consist of insoluble metallic salts of certified color additives, referred to as the Lakes or iron oxides. A pulverulent coloring agent, such as carbon black, chromium or iron oxides, ultramarines, manganese pyrophosphate, iron blue, and titanium dioxide, pearlescent agents, generally used as a mixture with colored pigments, or some organic dyes, generally used as a mixture with colored pigments can be added to the composition. In general, these coloring agents can be present in an amount by weight from 0 to 20% with respect to the weight of the final composition.

Pulverulent inorganic or organic additives can also be added, generally in an amount by weight from about 0 to about 40% with respect to the weight of the final composition, or any amount in-between these two values (e.g., about 5%, about 10%, about 15%, about 20%, about 25%, about 30%, about 35% or about 39%). These pulverulent fillers can be chosen from talc, micas, kaolin, zinc or titanium oxides, calcium or magnesium carbonates, silica, spherical titanium dioxide, glass or ceramic beads, metal soaps derived from carboxylic acids having about 8 to about 22 carbon atoms, non-expanded synthetic polymer powders, expanded powders and powders from natural organic compounds, such as cereal starches, which may or may not be cross-linked, copolymer microspheres such as EXPANCEL (Nobel Industrie), polytrap and silicone resin microbeads (TOSPEARL from Toshiba, for example).

Water soluble or water dispersible silicone polyether compositions may also be optional additives. These are also known as polyalkylene oxide silicone copolymers, silicone poly(oxyalkylene) copolymers, silicone glycol copolymers, or silicone surfactants. These can be linear rake or graft type materials, ABA or ABn type where the B is the siloxane polymer block, and the A is the poly(oxyalkylene) group. The poly(oxyalkylene) group can consist of polyethylene oxide, polypropylene oxide, or mixed polyethylene oxide/polypropylene oxide groups. Other oxides, such as butylene oxide or phenylene oxide are also possible. In some embodiments, the composition comprises an additive dye.

In some embodiments, the article or composition may further comprise a perfume or fragrance active ingredient commonly used in industry. These compositions typically belong to a variety of chemical classes, as varied as alcohols, aldehydes, ketones, esters, ethers, acetates, nitrites, terpenic hydrocarbons, heterocyclic nitrogen or sulphur containing compounds, as well as essential oils of natural or synthetic origin. Many of these perfume active ingredients are described in detail in standard textbook references such as Perfume and Flavor Chemicals, 1969, S. Arctander, Montclair, N.J.

In some embodiments, the article or composition comprises a wrapper, container, bottle, bottle cap, straw, bag (such as a single-use bag), eating utensil, plate, bowl, bottle, cup, or plate. In some embodiments, the article or composition comprises an article of packaging for clothing or a clothing item, for example, a shirt, shoe, pant, short, skirt, hair clip or tie, undergarment, glasses, contact lens, mask, hood, scarf, or sock.

### II. Methods

In another aspect, a method of forming a cross-link density gradient in an article comprising cross-linked polysaccharide or other water-soluble polymer, an outer surface, and an interior, is provided. The method comprises contacting the article with a solution comprising cross-linker or irradiating the article.

In some embodiments, the solution comprising a cross-linker comprises a solvent selected from water, an alcohol, DMSO, DMF, THF, ethers (i.e. diethyl ether, MTBE), toluene, methylene chloride, chloroform, or any other organic solvent well known in the art. In some embodiments, the cross-linker comprises one or more of Ca²⁺, Co²⁺, Zn²⁺, Cu²⁺, Mg²⁺, Ag²⁺, Ni²⁺, Ba²⁺, Pb²⁺, Sr²⁺, Cd²⁺, Fe²⁺, Fe³⁺, Mn⁺⁴, and V⁺⁵. In some embodiments, the solution is at a temperature of about 0 to about 100° C. In other aspects, the temperature range can be, for example, from about −20° C. to about 0° C., about 0° C. to about 20° C., about 20° C. to about 40° C., about 40° C. to about 60° C., about 60° C. to about 80° C., about 80° C. to about 100° C., about 100° C. to about 110° C., or a range defined by any two of the above recited values, or a subrange therewithin such a range.

In some embodiments, the contacting comprises submersion of the article or composition in the crosslinking solution. In some embodiments, the contacting is for greater than about 1 s, about 1 s to about 5 s, about 5 s to about 10 s, about 10 s to about 60 s, about 60 s to about 5 min, about 5 min to about 10 min, about 10 min to about 60 min, about 60 min to about 3 hr, about 3 hr to about 12 hr, about 12 hr to about 24 hr, about 24 hr to about 3 days, or about more than 3 days.

In some embodiments, irradiation is with gamma rays, X-rays, UV light, or infrared light. In some embodiments, irradiation is with one or more specific wavelengths of light between about 0.0001 nm to about 0.01 nm, about 0.01 nm to about 10 nm, about 10 nm to about 1,000 nm, or about 1,000 nm to about 0.01 cm.

Irradiation parameters, for example, including wavelength of light and time-irradiated, maybe be adjusted by those having ordinary skill in the art to effect asymmetric penetrations of the article. For, example, points within the interior of the composition or article will receive less incident light that points on the outer surface of the composition or article, and thus resultant cross-linking at the interior will be less than at the outer surface of the article or composition. The article or composition may be irradiated intermittently with multiple irradiations or continuously. In some embodiments, the irradiation is for a period of time of greater than about 1 s, about 1 s to about 5 s, about 5 s to about 10 s, about 10 s to about 30 s, about 30 s to about 1 min, about 1 min to about 10 min, about 10 min to about 20 min, or about 20 min to about 60 min, or longer, or a range defined by any two of the above recited values, or a subrange therewithin such a range.

In some embodiments, contacting the article or composition with a solution comprising cross-linker or irradiating the article or composition comprises contacting an pre-cross-linked article or composition with the solution comprising cross-linker or irradiating the article or composition. The pre-cross-linked article or composition, before contact or irradiation, may be about 1% to about 20%, about 20% to about 40%, about 40% to about 60%, about 60% to about 80%, or about 80% to about 99% cross-linked.

In some embodiments, the cross-linked water-soluble polymer is cast as a mold. The mold can be of the shape of the article. In some embodiments, the polymer is cast before cross-linking. In some embodiments, the polymer is cast after cross-linking. In some embodiments, the polymer is cast during cross-linking.

In some embodiments, the article or composition comprises a coating. The coating may be applied by techniques such as spraying onto the article or composition or dipping the article or composition in a solution or gas.

In another aspect, a method of recycling an article or composition comprising cross-linked water-soluble polymer, an outer surface, and an interior, is provided. The recycling method comprises decross-linking the cross-linked water-soluble polymer present in the article or composition, wherein the article or composition comprises a decreasing cross-link density gradient along a vector from the outer surface the article or composition to the interior the article or composition.

In some embodiments, decross-linking comprises contacting the article or composition with a solution. In some embodiments, the solution comprises a salt solution comprised mostly of monovalent cations. In some embodiments, the solution comprises a solvent selected from a solvent that will solvate cations, for example a polar solvent. In some embodiment, the solvent comprises a Ci to C6 alcohol, water, acetone, DMF (dimethylformamide), acetonitrile, dimethylsulfoxide (DMSO), γ-butyrolactone, or another protic or aprotic solvent well known in the art of chemistry. The article or composition may be submerged in, sprayed with, or doused with the solution to decross-link. In some embodiments, the contacting for decross-linking comprises contacting the article or composition with the solution for about 1 s to about 5 s, about 5 s to about 10 s, about 10 s to about 60 s, about 60 s to about 5 min, about 5 min to about 10 min, about 10 min to about 60 min, about 60 min to about 3 hr, about 3 hr to about 12 hr, about 12 hr to about 24 hr, about 24 hr to about 3 days, or about more than 3 days.

In some embodiments, the cross-links comprise photosensitive cross-links. In some embodiments, decross-linking comprises exposing the article to light. In some embodiments, the light comprises UV light or sunlight.

In some embodiments, the light comprises gamma rays, X-rays, UV light, or infrared light. In some embodiments, decross-linking comprises irradiation of the article with one or more specific wavelengths of light between about 0.0001 nm to about 0.01 nm, about 0.01 nm to about 10 nm, about 10 nm to about 1,000 nm, or about 1,000 nm to about 0.01 cm.

Irradiation parameters, for example, including wavelength of light and time-irradiated, may be adjusted by those having ordinary skill in the art to effect asymmetric penetrations of the article. For, example, points within the interior of the article or composition will receive less incident light that points on the outer surface of the article or composition, and thus resultant cross linking at the interior will be less than at the outer surface of the article or composition. The article or composition may be irradiated intermittently with multiple irradiations or continuously. In some embodiments, the irradiation is for a period of time of about 1 s to about 5 s, about 5 s to about 10 s, about 10 s to about 30 s, about 30 s to about 1 min, about 1 min to about 10 min, about 10 min to about 20 min, or about 20 min to about 60 min, or a range defined by any two of the above recited values, or a subrange therewithin such a range.

In some embodiments, decross-linking comprises removing about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, or about 100% of the cross-links in the article or composition. In some embodiments, the decross-linking initiates at the outer surface of the article or composition and proceeds to the interior of the article or composition.

### III. Definitions

Technical and scientific terms used herein have the meanings commonly understood by one of ordinary skill in the art, unless otherwise defined. Any suitable materials and/or methodologies known to those of ordinary skill in the art can be utilized in carrying out the methods described herein.

“Outer surface” as used herein, may refer to the surface area of the article or composition.

“Interior” as used herein when references a part of the article or composition described herein, refers to a region of space within the “outer surface” of the article or composition.

“Cross-link density” is the cation concentration, which is moles/volume (and hence a density).

A “cross-link” is an ionic bond that links one polymer chain to another. These links may take the form of covalent bonds or ionic bonds.

Ionic “cross-linking” involves the association of polymer chains by noncovalent interactions.

As used herein and in the claims, the term “hydrogel” is intended to refer to gels in which the cross-linked polymer matrix is fully or partially swollen with water, one or more water-compatible alcohols, or combinations thereof. Accordingly, the term also includes, but is not limited to, alcogels fully or partially swollen with a water-compatible alcohol. The cross-linking of the hydrogel polymer may be chemical or physical in nature. As non-limiting examples, the hydrogel may be cross-linked through covalent bonds, ionic interactions, hydrogen bonding, chain entanglement, or self-association of microphase segregating moieties. Additionally, it is to be understood that such hydrogels may exist and be used in a dehydrated (unswollen) state.

As used herein, the term “organic functional group” is intended to refer to a halo group, alcohol group, aldehyde group, ketone group, carboxylic acid group, alkene group, and/or alkyne group. Depending on whether chlorine, bromine, or iodine atom is attached to a carbon atom of the organic compound, the halo group can be chloro (—Cl), bromo (—Br), or iodo (—I). An alcohol group contains one oxygen and one hydrogen atom joined together (—OH). One carbon atom, one hydrogen atom, and one oxygen atom are joined together to form the aldehyde group (—CHO). All aldehydes contain the carbonyl group, which is a double bond between carbon and oxygen. One carbon atom and one oxygen atom make up the ketone group (—CO—). A carboxylic acid is an organic molecule with a carbon (C) atom double-bonded to an oxygen (O) atom and a single-bonded hydroxyl group (OH). The alkene group is a carbon-carbon double bond, and the alkyne group is a carbon-carbon triple bond.

As used herein and in the claims, the singular forms “a,” “an,” and “the” include the plural reference unless the context clearly indicates otherwise. Throughout this specification, unless otherwise indicated, “comprise,” “comprises” and “comprising” are used inclusively rather than exclusively. The term “or” is inclusive unless modified, for example, by “either.” Thus, unless context or an express statement indicates otherwise, the word “or” means any one member of a particular list and also includes any combination of members of that list. Other than in the examples, or where otherwise indicated, all numbers expressing quantities of ingredients or reaction conditions used herein should be understood as modified in all instances by the term “about.”

Headings are provided for convenience only and are not to be construed to limit the invention in any way. Unless defined otherwise, all technical and scientific terms used herein have the same meaning as those commonly understood to one of ordinary skill in the art. The terminology used herein is for the purpose of describing particular embodiments only and is not intended to limit the scope of the present invention, which is defined solely by the claims. In order that the present disclosure can be more readily understood, certain terms are first defined. Additional definitions All numerical designations, e.g., pH, temperature, time, concentration, and molecular weight, including ranges, are approximations which are varied (+) or (−) by increments of 1, 5, or 10%. It is to be understood, although not always explicitly stated that all numerical designations are preceded by the term “about.” It also is to be understood, although not always explicitly stated, that the reagents described herein are merely exemplary and that equivalents of such are known in the art and are set forth throughout the detailed description.

As used herein, the term “comprising” or “comprises” is intended to mean that the compositions and methods include the recited elements, but not excluding others. “Consisting essentially of” when used to define compositions and methods, shall mean excluding other elements of any essential significance to the combination for the stated purpose. Thus, a composition consisting essentially of the elements as defined herein would not exclude other materials or steps that do not materially affect the basic and novel characteristic(s) of the claimed invention. “Consisting of” shall mean excluding more than trace elements of other ingredients and substantial method steps. Embodiments defined by each of these transition terms are within the scope of this invention. When an embodiment is defined by one of these terms (e.g., “comprising”) it should be understood that this disclosure also includes alternative embodiments, such as “consisting essentially of” and “consisting of” for said embodiment.

“Substantially” or “essentially” means nearly totally or completely, for instance, 95%, 96%, 97%, 98%, 99%, or greater of some given quantity.

The term “about” will be understood by persons of ordinary skill in the art and will vary to some extent depending upon the context in which it is used. If there are uses of the term which are not clear to persons of ordinary skill in the art given the context in which it is used, “about” will mean up to plus or minus 10% of the particular term. For example, in some embodiments, it will mean plus or minus 5% of the particular term. Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number, which, in the context in which it is presented, provides the substantial equivalent of the specifically recited number.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the disclosure.

Embodiments described herein are further illustrated by, though in no way limited to, the following working examples.

### EXAMPLES

### Example 1: Partially (25%) Cross-linked Polymer Synthesis

The purpose of this example was to prepare exemplary articles or compositions comprising a partially cross-linked water-soluble polymer, an outer surface, and an interior, wherein the article comprises a cross-link density gradient along a vector from the outer surface to the interior of the article.

Sodium alginate was dissolved in deionized (DI) water to make a 5 wt. % sodium alginate solution. 10 g of the solution (2.53 mmol alginate) was transferred to a silicone mold. To the alginate solution, 467 mg (5.07 mmol) of glycerol was added dropwise. 118 mg of ethylenediaminetetraacetic acid (EDTA) calcium disodium salt (0.316 mmol) was dissolved in 5 g of DI water and added to the alginate solution in the mold. 112 mg of glucono delta-lactone (0.630 mmol) was dissolved in 15 g DI water and immediately added to the alginate solution in the mold. The solution was stirred in the mold until well mixed, then dried in air for 48 hours.

The resultant article or composition comprised a partially cross-linked water-soluble polymer, an outer surface, and an interior, wherein the article comprises a cross-link density gradient along a vector from the outer surface to the interior of the article

### Example 2: Additional Cross-Linking of Dried Polymer

The purpose of this example was to subject the dried composition or articles prepared as described in Example 1 to additional cross-linking.

The partially cross-linked samples from Example 1 were divided and submerged in 40 mL of a cross-linking solution containing one of the following: 0.045 mol CaCl₂) (FIG. 1A), CuSO₄ (FIG. 1B), MnCl₂ (FIG. 1C), CoSO₄ (FIG. 1D), NiCl₂ (FIG. 1E), and FeCl₃ (FIG. 1F) per 100 g deionized water (DI) for 10 seconds and 60 seconds.

This process creates a gradient of cross-links via diffusion from the surface of the article or composition to the interior of the article or composition. The samples were then removed from the solution and air-dried for 19 hours.

### Example 3: Dissolution of Cross-Linked Alginate Plastics

The purpose of this example is to subject the fully cross-linked articles or compositions from Example 2 to conditions resulting in dissolution of the cross-linked alginate plastics.

Half of the sample from the 10 second exposure and half of the sample from the 60 second exposure from Example 2 were suspended in 250 mL of DI water and stirred at 800 RPM for various periods of time (see the panel labeled “DI Water” for FIGS. 1A-1F), while the other half of the samples were suspended and stirred in 250 mL of 3 wt % NaCl for various periods of time (see the panel labeled “Salt Water” for FIGS. 1A-1F).

All solutions were replaced every 48 hours with fresh solution.

CaCl₂) crosslinking results: For the sample shown in FIG. 1A, corresponding to samples with cross-linking facilitated by CaCl₂), which is a divalent crosslinker, the 10 second and 60 second exposure samples were removed from the DI water after 2 and 4 days, respectively, and dried in air. As shown in the DI panel of FIG. 1A, the alginate plastics retained their shape, even after a prolonged period in water. However, a marked contrast was seen in the stability and lack of structure retention following exposure of the samples to salt water. Specifically, after the 10 second and 60 second exposure samples were exposed to salt water for 5 and 6 days, respectively, and then dried in air, it is clear from the pictures shown in FIG. 1A that the alginate plastics are degrading and losing their physical structure.

CuSO₄ crosslinking results: For the sample shown in FIG. 1B, corresponding to samples with cross-linking facilitated by CuSO₄, which is a divalent crosslinker, the 10 second and 60 second exposure samples were removed from the DI water after 2 and 4 days, respectively, and dried in air. As shown in the DI panel of FIG. 1B, the alginate plastics retained their shape, with each side of both articles clearly defined, even after a prolonged period in water. However, a marked contrast was seen in the stability and lack of structure retention following exposure of the samples to salt water. Specifically, after the 10 second and 60 second exposure samples were exposed to salt water for 3 days, and then dried in air, it is clear from the pictures shown in FIG. 1B that the alginate plastics are degrading and demonstrating a significant loss of physical structure, as none of the sides of each of the articles remains clearly defined, and instead resemble a “blob-like” or amorphous structure.

MnCl₂ crosslinking results: For the sample shown in FIG. 1C, corresponding to samples with cross-linking facilitated by MnCl₂, which is a divalent crosslinker, the 10 second and 60 second exposure samples were removed from the DI water after 2 days, and dried in air. As shown in the DI panel of FIG. 1C, the alginate plastics completely retained their shape, with each side of both articles clearly defined, even after a prolonged period in water. However, a marked contrast was seen in the stability and lack of structure retention following exposure of the samples to salt water. Specifically, after the 10 second and 60 second exposure samples were exposed to salt water for 3 days, and then dried in air, it is clear from the pictures shown in FIG. 1C that the alginate plastics are completely degrading and demonstrating a significant loss of physical structure, as none of the sides of each of the articles remains clearly defined. Instead, both articles exhibit a “blob-like” or amorphous physical structure.

CoSO₄ crosslinking results: For the sample shown in FIG. 1D, corresponding to samples with cross-linking facilitated by CoSO₄, which is a divalent crosslinker, the 10 second and 60 second exposure samples were removed from the DI water after 2 days, and dried in air. As shown in the DI panel of FIG. 1D, the alginate plastics completely retained their shape, with each side of both articles clearly defined, even after a prolonged period in water. However, a marked contrast was seen in the stability and lack of structure retention following exposure of the samples to salt water. Specifically, after the 10 second and 60 second exposure samples were exposed to salt water for 8 days, and then dried in air, it is clear from the pictures shown in FIG. 1D that the alginate plastics are completely degrading and demonstrating a significant loss of physical structure, as none of the sides of each of the articles remains clearly defined. Instead, both articles exhibit a “blob-like” or amorphous physical structure.

NiCl₂ crosslinking results: For the sample shown in FIG. 1E, corresponding to samples with cross-linking facilitated by NiCl₂, which is a divalent crosslinker, the 10 second and 60 second exposure samples were removed from the DI water after 2 days, and dried in air. As shown in the DI panel of FIG. 1E, the alginate plastics retained their shape, with each side of both articles defined, even after a prolonged period in water. However, a marked contrast was seen in the stability and lack of structure retention following exposure of the samples to salt water. Specifically, after the 10 second and 60 second exposure samples were exposed to salt water for 8 days, and then dried in air, it is clear from the pictures shown in FIG. 1E that the alginate plastics are completely degrading and demonstrating a significant loss of physical structure, as none of the sides of each of the articles remains clearly defined. Instead, both articles exhibit a “blob-like” or amorphous physical structure.

FeCl₃ crosslinking results: For the sample shown in FIG. 1F, corresponding to samples with cross-linking facilitated by FeCl₃, which is a trivalent crosslinker, the 10 second and 60 second exposure samples were removed from the DI water after 1 day, and dried in air. As shown in the DI panel of FIG. 1F, the alginate plastics exposed for 60 sec retained its shape, although the sample exposed to the crosslinker for 10 seconds shows some initial decomposition. After the 10 second and 60 second exposure samples were exposed to salt water for 4 days, and then dried in air, the alginate plastics show the beginning of degradation (see FIG. 1F), although this is more prevalent with the 60 sec exposure sample.

The visual evidence in FIGS. 1A-1F show that the alginate plastic samples exposed to DI water have largely retained their shape, while the alginate plastic samples exposed to salt water have not retained their shape. In particular, the samples exposed to DI water can be manipulated with tweezers and remain free-standing, while those exposed to salt water fall apart when mechanically stressed by tweezers.

This example demonstrates the successful implementation of developing a plastic that retains its form and shape in water, but which readily degrades when exposed to salt water or conditions that mimic exposure to an ocean.

### Example 4: Additional Cross-Linking of Dried Polymer & Subsequent Dissolution

The purpose of this example is to describe a process for additional cross-linking of the partially cross-linked article or composition from Example 1, and a subsequent process for dissolution of the cross-linked article or composition.

The partially cross-linked samples of Example 1 were divided and submerged in 40 mL of a 5 wt. % calcium chloride/DI water solution for 5 hours (FIG. 2A), and 30 minutes, (FIG. 2B). This process creates a gradient of Ca cross-links via diffusion from the surface to the interior.

Following exposure to the CaCl₂) cross-linking solution, the samples were removed from the solution and air-dried for 19 hours. As shown in the top panel of FIGS. 2A and 2B, exposure to a cross-linking solution increased the integrity and solidified the physical structure of the composition/article. In particular, the samples shown in FIGS. 2 A and 2B show clearly defined edges and a characteristic structure, distinct from that of an amorphous structure.

Dissolution of the cross-linked alginate plastics: One sample from the 5 hour exposure and one from the 30 minute exposure were suspended in 250 mL of DI water and stirred at 800 RPM for 6 days (FIG. 2C), while the other two samples were suspended and stirred in 250 mL of 3 wt % NaCl for 4 days (FIG. 2D). All solutions were replaced every 48 hours with fresh solution.

After 6 days (5 hours sample) and 4 days (30 min sample), the samples were removed from the solutions and dried in air.

The visual evidence in FIGS. 2C and 2D shows that the alginate plastic samples exposed to DI water have largely retained their shape. See the left panel of each of FIGS. 2C and 2D. However, in sharp contrast, the samples exposed to salt water did not retain their shape, and instead formed an amorphous structure with no clearly delineated edges or lines (FIGS. 2C and 2D). In particular, the samples exposed to DI water could be manipulated with tweezers and remain free-standing, while those exposed to salt water fall apart when stressed by tweezers.

This example demonstrates the successful generation of an alginate plastic, followed by dissolution of the plastic composition or article under conditions that mimic ocean or salt water environmental conditions.

### Example 5: Crosslinking Capability of Diamines

The purpose of this example is to demonstrate the crosslinking capability of diamines using L-Lysine and poly(sodium alginate). The isoelectric point of L-Lysine is 9.80 units (Haynes et al., 2017). The pKₐ of sodium alginate ranges from 3.38 to 3.65 units depending on the isomeric composition of the polymer chain (Haug 1963).

Sodium alginate (MilliporeSigma) was mixed with Milli-Q grade deionized water to form a 12.7 wt % solution of sodium alginate in water. The solution was applied to a sheet of high-density polyethylene using a wire-wound drawdown bar to form a thin film. The film was allowed to air dry overnight and resulted in a final thickness of about 20 micrometers. A 2 cm by 2 cm square of the alginate film was cut and placed in a solution of 0.2 M L-lysine (MilliporeSigma) in deionized water for 20 seconds. Another sample was placed in deionized water for 30 seconds as a control. Both films were allowed to air dry prior to further analysis.

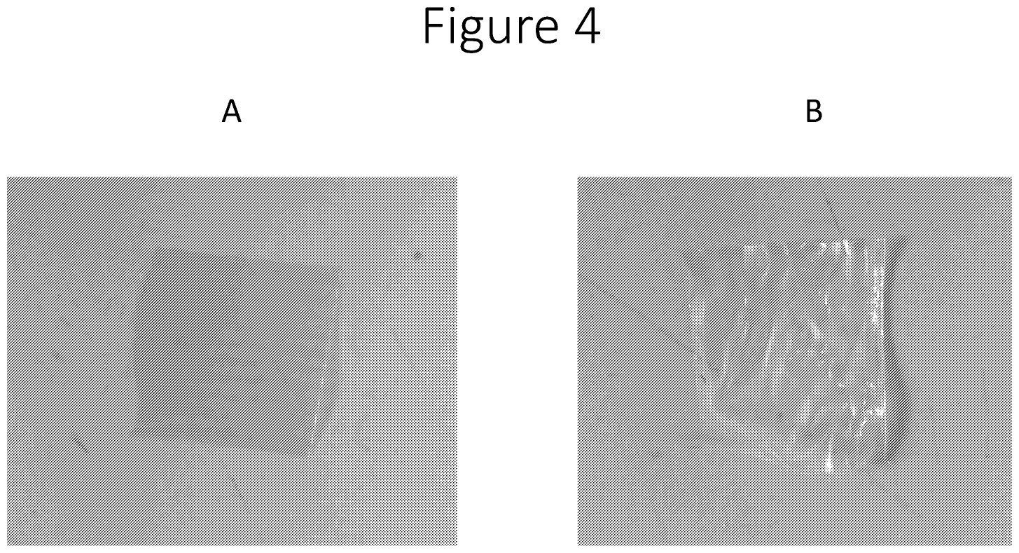

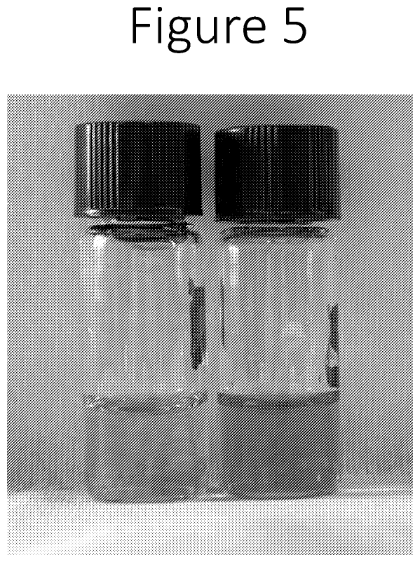

The alginate contacted with deionized water dissolved instantaneously upon contact. Conversely, the alginate film contacted with the L-lysine solution remained intact upon immersion. The film contacted with L-lysine exhibited visible wrinkles upon drying, which is indicative of syneresis—a processes in which biopolymer networks contract as a result of crosslinking (Draget et al., 2001). Once dry, the alginate crosslinked with L-lysine appeared to be significantly stronger than the uncrosslinked alginate film. FIG. 4A depicts yncrosslinked alginate film, with little to no wrinkling, and FIG. 4B depicts an alginate film crosslinked with L-Lysine, showing wrinkling because of syneresis.

Reversibility of the lysine crosslinking was tested by immersing two identical lysine-crosslinked films in deionized water and 3 wt % salt water for 24 hours. The degree of decrosslinking was determined by comparing the concentration of dissolved amine groups at the end of the 24-hour immersion using the ninhydrin test. If dissolved amines are present in the water surrounding the crosslinked alginate sample, adding ninhydrin will turn the solution a purple-blue hue. If no amines are present, then the water will remain mostly colorless with a slight yellow tint due to the yellow color of the ninhydrin. Intensity of the blue color is positively correlated with the concentration of the amine in the surrounding water (Kaiser et al., 1970).

The ninhydrin test was performed on the water surrounding both samples to determine the relative amount of dissolved amine present. A 0.50 mL sample of each water solution was first placed in a glass vial. A 0.02M solution of ninhydrin (ThermoFisher Scientific) in isopropanol was prepared and 0.20 mL of this solution was added to the vial. The vial was placed in a boiling water bath for 5 minutes before being cooled to room temperature. FIG. 5 shows the vials after being cooled. The lysine-crosslinked sample placed in deionized water retained a slight yellow-orange tint (left vial), while the sample placed in salt water turned a blue-purple color (right vial), indicating that the saltwater triggers decrosslinking of the lysine-crosslinked polymer.

Tensile testing was performed on a lysine-crosslinked alginate sample. The sample crosslinked with lysine showed a higher ultimate strength and a lower maximum strain, which are both characteristic of a crosslinked polymer network (Rubinstein 2003). FIG. 6 shows the stress vs. strain plot for an uncrosslinked alginate sample and the lysine-crosslinked sample.

### Example 6: Crosslinking Capability of Diamines

The purpose of this example was to demonstrate the higher strength of crosslinked samples.

Sodium alginate (MilliporeSigma) was mixed with Milli-Q grade deionized water to form a 12.7 wt % solution of sodium alginate in water. The solution was applied to a sheet of high-density polyethylene using a wire-wound drawdown bar to form a thin film. The film was allowed to air dry overnight and resulted in a final thickness of about 20 micrometers. A segment of the alginate film was cut and placed in a solution of 5 wt % CaCl₂) for 30 seconds. The film was allowed to air dry.

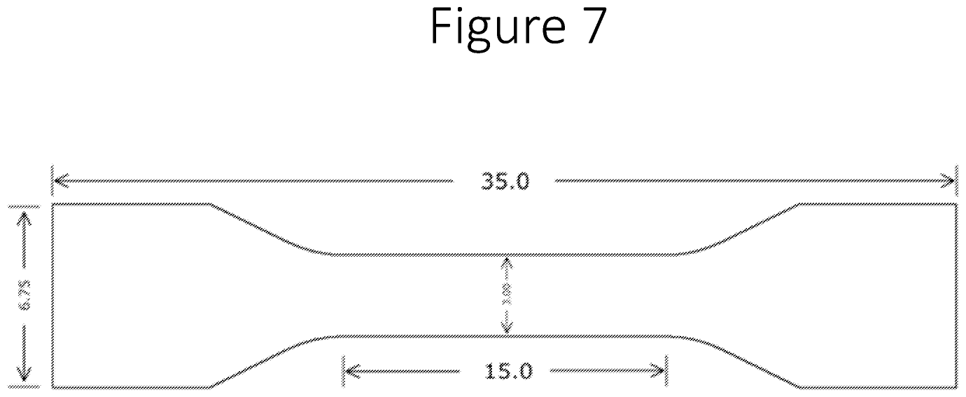

A uniaxial elongation tensile test was performed on samples of crosslinked and uncrosslinked sodium alginate using an ADMET uniaxial mechanical tester. Samples were cut into a dog-bone shape (dimensions shown in FIG. 7). The sample was uniaxially-extended at a rate of 2 mm/min, with force measurements taken continuously until the sample fractured. These datasets were used to calculate the stress and strain, which can be analyzed to determine mechanical properties of the material. One of the most important properties is the ultimate tensile strength, which is the maximum amount of force the material can withstand per unit area without fracturing (David, 2004). On a stress vs. strain plot, the ultimate tensile strength can be calculated as the maximum stress divided by the corresponding strain.

Crosslinking of polymer chains creates a significantly stronger polymer network (Rubinstein, 2003), resulting in a higher ultimate strength of the crosslinked polymer as compared to the uncrosslinked polymer. This was observed in the mechanical properties of sodium alginate. The uncrosslinked sodium alginate sample exhibited an ultimate strength of about 250 MPa, while the crosslinked sample exhibited an ultimate strength of about 460 MPa, as shown in FIG. 8. The higher strength of the crosslinked sample proves that the crosslinking is effective, and that higher calcium content corresponds to increased film strength.

### Example 7: Demonstration of Gradient Crosslink Density

The purpose of the example was to demonstrate gradient crosslink density.

Sodium alginate was partially (25%) crosslinked with calcium as described in Example 1 of the disclosure. The sample was then further crosslinked by immersion in a 5 wt % solution of copper (II) sulfate. Samples were immersed for 0, 5, 10, 30, 60, and 300 seconds.

The alginate samples were dried before being immersed in an aqueous solution of 1 M nitric acid to release the water-soluble ions from the alginic material. The concentration of copper in the acidic solution was determined via inductively coupled plasma optical emission spectroscopy (ICP-OES) (Agilent Technologies). The concentration of copper in each crosslinked alginate sample was then calculated from these data.

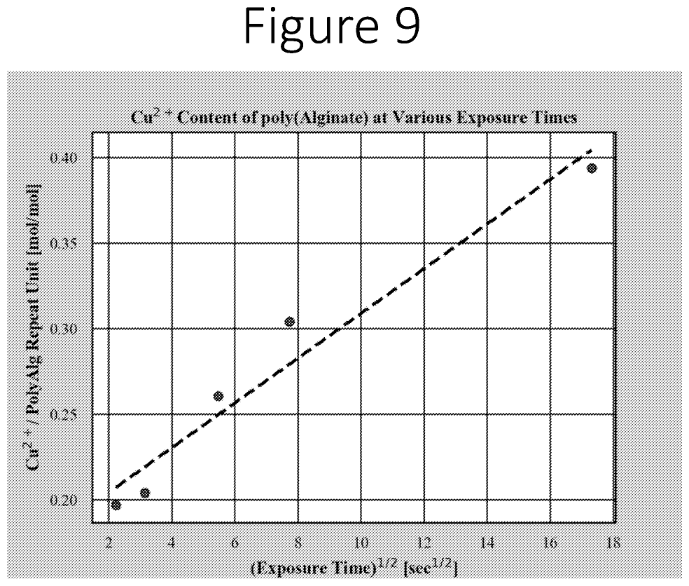

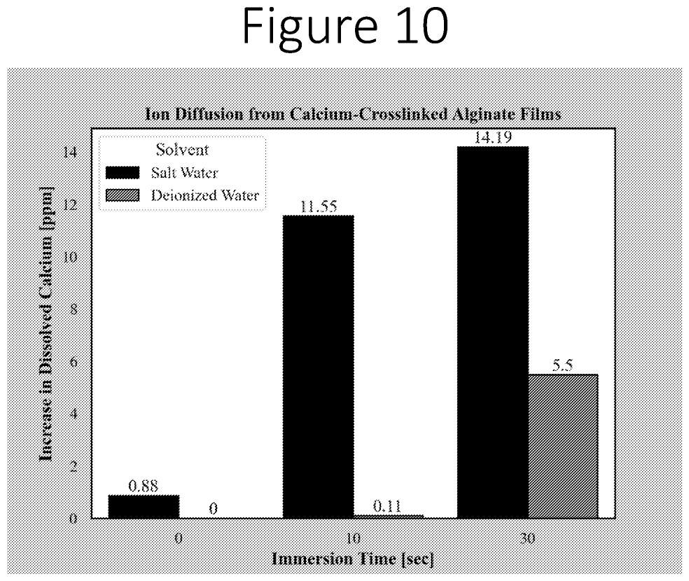

Fick's second law of diffusion states that concentration will increase linearly with the square root of time (Welty, 2014). The diffusion of copper into the film is shown to obey Fick's law, as proven in FIG. 9 where cooper ion concentration as measured by ICP-OES is plotted against the square root of time. The linear fit is statistically significant (p=0.02), confirming that the ions diffuse into the material in a gradient fashion.

### Example 8: Evidence of Dissolution of Crosslinked Films

The purpose of this example was to provide evidence of dissolution of crosslinked films.

Sodium alginate (MilliporeSigma) was mixed with Milli-Q grade deionized water to form a 12.7 wt % solution of sodium alginate in water. The solution was applied to a sheet of high-density polyethylene using a wire-wound drawdown bar to form a thin film. The film was allowed to air dry overnight and resulted in a final thickness of about 20 micrometers. A segment of the alginate film was cut and placed in a solution of 5 wt % CaCl₂) for 0, 10, and 30 seconds. The film was allowed to air dry before further analysis.

The films were placed in deionized water and 3 wt % salt water for 24 hours, with samples of the water taken before and after immersion. The water samples were acidified using 1 M nitric acid and analyzed for calcium concentration using inductively coupled plasma optical emission spectrometry (Agilent Technologies). The increase in amount of calcium in the water surrounding the submerged alginate film at the end of the 24-hour period was measured and is shown in FIG. 10. These data shows that the calcium leaves the alginate film much more readily in salt water compared to deionized water, proving the reversibility of the crosslinks.

Although the foregoing refers to particular preferred embodiments, it will be understood that the present invention is not so limited. It will occur to those of ordinary skill in the art that various modifications may be made to the disclosed embodiments and that such modifications are intended to be within the scope of the present invention.

All of the publications, patent applications and patents cited in this specification are incorporated herein by reference in their entirety. Further embodiments are set forth in the following claims.

### REFERENCES

Jambeck et al., (2015). Plastic waste inputs from land into the ocean. Science, 347(6223), 768-771.
Foley et al., (2018). A meta-analysis of the effects of exposure to microplastics on fish and aquatic invertebrates. Science of the Total Environment, 631, 550-559.
Lehner et al., (2019). Emergence of nanoplastic in the environment and possible impact on human health. Environmental science & technology, 53(4), 1748-1765.
Brooks, A. L., Wang, S., & Jambeck, J. R. (2018). The Chinese import ban and its impact on global plastic waste trade. Science advances, 4(6), eaat0131.
Karamanlioglu, M., Preziosi, R., & Robson, G. D. (2017). Abiotic and biotic environmental degradation of the bioplastic polymer poly (lactic acid): a review. Polymer Degradation and stability, 137, 122-130.
Andreopoulos, F. M., Beckman, E. J., & Russell, A. J. (1998). Light-induced tailoring of PEG-hydrogel properties. Biomaterials, 19(15), 1343-1352.
Andreopoulos, F. M., Beckman, E. J., & Russell, A. J. (2000). Photoswitchable PEG?CA hydrogels and factors that affect their photosensitivity. Journal of Polymer Science Part A: Polymer Chemistry, 38(9), 1466-1476.
Trenor, S. R., Long, T. E., & Love, B. J. (2004). Photoreversible chain extension of poly (ethylene glycol). Macromolecular Chemistry and Physics, 205(6), 715-723.
Dissociation Constants of Organic Acids and Bases. In CRC Handbook of Chemistry and Physics, Haynes et al., Eds.; CRC Press, 2017.
Haug, A.; Larsen, B. The Solubility of Alginate at Low pH. Acta Chemica Scandinavica 1963, 17, 1653-1662. DOI: 10.3891/acta.chem.scand.17-1653.
Draget et al., Effects of molecular weight and elastic segment flexibility on syneresis in Ca-alginate gels. Food Hydrocolloids 2001, 15 (4), 485-490. DOI: 10.1016/S0268-005X(01)00046-7.
Kaiser et al., Color test for detection of free terminal amino groups in the solid-phase synthesis of peptides. Analytical Biochemistry 1970, 34 (2), 595-598. DOI: 10.1016/0003-2697(70)90146-6.
Rubinstein, M.; Colby, R. H. Polymer Physics; Oxford University Press, 2003.
Davis, J. R. Tensile Testing; ASM International, 2004.
Welty, J. R.; Rorrer, G. L.; Foster, D. G. Fundamentals of Momentum, Heat, and Mass Transfer; Wiley, 2014.

### Embodiments

Embodiment P1. An article comprising cross-linked water-soluble polymer, an outer surface, and an interior, wherein the article comprises a cross-link density gradient along a vector from the outer surface to the interior of the article.

Embodiment P2. The article of embodiment P1, comprising a decreasing cross-link density along the vector.

Embodiment P3. The article of embodiment P1 or P2, wherein the cross-links comprise ionic cross-links or a combination thereof.

Embodiment P4. The article of embodiment P3, wherein the cross-links comprise ionic cross-links that include one or more of Ca²⁺, Co²⁺, Zn²⁺, Cu²⁺, Mg²⁺, Ag²⁺, Ni²⁺, Ba²⁺, Pb²⁺, Sr²⁺, Cd²⁺, Fe²⁺, Fe³⁺, Mn⁺⁴, and V⁺⁵.

Embodiment P5: The article of any one of P1-P3, wherein the cross-links comprise ionic cross-links formed by an organic compound comprising two or more amine groups. In addition, the cross-links can comprise a multi-functional amine, wherein a multifunctional amine is defined as a cross-linker having a number of amine groups per molecule which is greater than or equal to two, and wherein the amine is defined as NR₁R₂R₃, wherein each R can be H or another organic functional group.

Embodiment P6. The method of any one of embodiments P1-P5, wherein the cross-link density gradient decreases along the vector about 10% or more, about 10% to about 20%, about 20% to about 30%, about 30% to about 40%, about 40% to about 50%, about 50% to about 60%, about 60% to about 70%, about 70% to about 80%, about 80% to about 90%, or about 90% to about 95% of the cross-link density that is at the outer surface of the article, at a point in the interior on the vector.

Embodiment P7. The method of any one of embodiments P1-P6, wherein the cross-link density decreases along the vector from a point closer to the outer surface of the article, to a point in the interior and on the vector.

Embodiment P8. The article of embodiment P7, wherein the cross-link density at the point in the interior and on the vector has a cross-link density that is about 1% to about 20%, about 20% to about 40%, about 40% to about 60%, about 60% to about 80%, or about 80% to about 99% of the cross-link density at the point closer to the outer surface of the article.

Embodiment P9. The article of any one of embodiments P1-P8, wherein the article further comprises one or more additives selected from the group consisting of water, glycerol, propane diol, and glycol ethers.

Embodiment P10. The article of any one of embodiments P1-P9, wherein the article comprises a wrapper, container, bottle, bag, straw, bottle cap, eating utensil, plate, bowl, cup, an article of packaging for clothing, or clothing.

Embodiment P11. A method of forming a cross-link density gradient in an article comprising cross-linked water-soluble polymer, an outer surface, and an interior, wherein the method comprises contacting the article with a solution comprising cross-linker.

Embodiment P12. The method of embodiment P11, wherein the cross-links comprise ionic cross-links and the cross-linker comprises one or more of Ca²⁺, Co²⁺, Zn²⁺, Cu²⁺, Mg²⁺, Ag²⁺, Ni²⁺, Ba²⁺, Pb²⁺, Sr²⁺, Cd²⁺, Fe²⁺, Fe³⁺, Mn⁺⁴, and V⁺⁵.

Embodiment P13: The method of embodiment P11, wherein the cross-links comprise ionic cross-links formed by an organic compound comprising two or more amine groups. In addition, the cross-links can comprise a multi-functional amine, wherein a multifunctional amine is defined as a cross-linker having a number of amine groups per molecule which is greater than or equal to two, and wherein the amine is defined as NR₁R₂R₃, wherein each R can be H or another organic functional group.

Embodiment P14. The method of embodiment P11, P12, or P13, wherein the cross-link density gradient decreases along a vector from the outer surface to the interior.

Embodiment P15. The method of any one of embodiments P11-P14, wherein the article comprising cross-linked water-soluble polymer is about 1% to about 20%, about 20% to about 40%, about 40% to about 60%, about 60% to about 80%, or about 80% to about 99% cross-linked before contacting the article with the solution.

Embodiment P16. The method of any one of embodiments P11-P15, wherein contacting comprises submersion of the article in the solution.

Embodiment P17. The method of any one of embodiments P11-P16, wherein contacting comprises diffusing the solution along the vector from the outer surface to the interior.

Embodiment P18. The method of any one of embodiments P11-P17, wherein contacting is for about 5 min to about 30 min, about 30 min to about 1 hr, about 1 hr to about 2 hr, about 2 hr to about 3 hr, about 3 hr to about 4 hr, about 4 hr to about 5 hr, about 5 hr to about 6 hr, about 6 hr to about 8 hr, about 8 hr to about 16 hr, or greater than about 16 hr.

Embodiment P19. The method of any one of embodiments P11-P18, further comprising drying the article after the contacting.

Embodiment P20. A method of recycling an article comprising cross-linked water-soluble polymer, an outer surface, and an interior, wherein: the article comprises a decreasing cross-link density gradient along a vector from the outer surface to the interior, and the method comprises decross-linking the cross-linked water-soluble polymer.

Embodiment P21. The method of embodiment P20, wherein the decross-linking initiates at the outer surface and proceeds to the interior.

Embodiment P22. The method of embodiment P21, wherein the decross-linking rate increases along the vector.

Embodiment P23. The method of any one of embodiments P20-P22, wherein the cross-links comprise ionic cross-links.

Embodiment P24. The method of embodiment P23, wherein the ionic cross-links comprise one or more of Ca²⁺, Co²⁺, Zn²⁺, Cu²⁺, Mg²⁺, Ag²⁺, Ni²⁺, Ba²⁺, Pb²⁺, Sr²⁺, Cd²⁺, Fe²⁺, Fe³⁺, Mn⁺⁴, and V⁺⁵.

Embodiment P25: The method of embodiment P23, wherein the cross-links comprise ionic cross-links formed by an organic compound comprising two or more amine groups. In addition, the cross-links can comprise a multi-functional amine, wherein a multifunctional amine is defined as a cross-linker having a number of amine groups per molecule which is greater than or equal to two, and wherein the amine is defined as NR₁R₂R₃, wherein each R can be H or another organic functional group.

Embodiment P26. The method of any one of embodiments P20-P25, wherein decross-linking comprises contacting the article with a salt solution comprised mostly of monovalent cations.

1. An article comprising a cross-linked water-soluble polymer, an outer surface, and an interior, wherein the article comprises a cross-link density gradient along a vector from the outer surface to the interior of the article.

2. The article of claim 1, comprising a decreasing cross-link density along the vector.

3. The article of claim 1, wherein cross-links of the water-soluble polymer comprise ionic cross-links.

4. The article of claim 1, wherein the cross-links comprise an organic compound, an inorganic compound, or a combination thereof.

5. The article of claim 1, wherein the cross-links comprise ionic cross-links formed by an organic compound comprising two or more amine groups.

6. The article of claim 1, wherein the cross-links comprise a multi-functional amine, wherein a multifunctional amine is defined as a cross-linker having a number of amine groups per molecule which is greater than or equal to two, and wherein the amine is defined as NR₁R₂R₃, wherein each R can be H or another organic functional group.

7. The article of claim 3, wherein the ionic cross-links comprise one or more of Ca²⁺, Co²⁺, Zn²⁺, Cu²⁺, Mg²⁺, Ag²⁺, Ni²⁺, Ba²⁺, Pb²⁺, Sr²⁺, Cd²⁺, Fe²⁺, Fe³⁺, Mn⁺⁴, and V⁺⁵.

8. The article of claim 1, wherein the cross-link density gradient decreases along the vector about 10% or more, about 10% to about 20%, about 20% to about 30%, about 30% to about 40%, about 40% to about 50%, about 50% to about 60%, about 60% to about 70%, about 70% to about 80%, about 80% to about 90%, or about 90% to about 95% of the cross-link density that is at the outer surface of the article, at a point in the interior on the vector.

9. The article of claim 1, wherein the cross-link density decreases along the vector from a point closer to the outer surface of the article, to a point in the interior and on the vector.

10. The article of claim 9, wherein the cross-link density at the point in the interior and on the vector has a cross-link density that is about 1% to about 20%, about 20% to about 40%, about 40% to about 60%, about 60% to about 80%, or about 80% to about 99% of the cross-link density at the point closer to the outer surface of the article.

11. The article of claim 1, wherein the article further comprises one or more additives selected from the group consisting of water, glycerol, propane diol, and glycol ethers.

12. The article of claim 1, wherein the article comprises a wrapper, container, bottle, a bag such as but not limited to a single-use bag, straw, bottle cap, eating utensil, plate, bowl, cup, an article of packaging, film and sheeting, packing materials, trash bags, kitchenware, bottle stopper or screw lid, shopping bags, toiletries containing microbeads, personal care products such as hairbrush and toothbrush, writing utensils, countertops, carpeting and rugs, traffic cones, medical components, outdoor furniture, toys, luggage, car parts, construction materials, cell phone case, or a clothing or shoe item.

13. A method of forming a cross-link density gradient in an article comprising a cross-linked water-soluble polymer, an outer surface, and an interior, wherein the method comprises contacting the article with a solution comprising cross-linker.

14. The method of claim 13, wherein the cross-link density gradient decreases along a vector from the outer surface to the interior.

15. The method of claim 13, wherein cross-links of the polymer comprise ionic cross-links.

16. The method of claim 13, wherein the cross-links comprise an organic compound, an inorganic compound, or a combination thereof.

17. The method of claim 13, wherein the cross-links comprise ionic cross-links formed by an organic compound comprising two or more amine groups.

18. The method of claim 13, wherein the cross-links comprise a multi-functional amine, wherein a multifunctional amine is defined as a cross-linker having a number of amine groups per molecule which is greater than or equal to two, and wherein the amine is defined as NR₁R₂R₃, wherein each R can be H or another organic functional group.

19. The method of claim 15, wherein the ionic cross-links comprise ionic cross-links that comprise one or more of Ca²⁺, Co²⁺, Zn²⁺, Cu²⁺, Mg²⁺, Ag²⁺, Ni²⁺, Ba²⁺, Pb²⁺, Sr²⁺, Cd²⁺, Fe²⁺, Fe³⁺, Mn⁺⁴, and V⁺⁵.

20. The method of claim 13, wherein the article comprising the cross-linked water-soluble polymer is about 1% to about 20%, about 20% to about 40%, about 40% to about 60%, about 60% to about 80%, or about 80% to about 99% cross-linked before contacting the article with the solution.

21. The method of claim 13, wherein contacting comprises submersion of the article in the solution.

22. The method of claim 13, wherein contacting comprises diffusing the solution along the vector from the outer surface to the interior.

23. The method of claim 13, wherein contacting is for about 5 min to about 30 min, about 30 min to about 1 hr, about 1 hr to about 2 hr, about 2 hr to about 3 hr, about 3 hr to about 4 hr, about 4 hr to about 5 hr, about 5 hr to about 6 hr, about 6 hr to about 8 hr, about 8 hr to about 16 hr, or greater than about 16 hr.

24. The method of claim 13, further comprising drying the article after the contacting.

25. A method of recycling an article comprising cross-linked water-soluble polymer, an outer surface, and an interior, wherein:
(a) the article comprises a decreasing cross-link density gradient along a vector from the outer surface to the interior, and
(b) the method comprises decross-linking the cross-linked water-soluble polymer.

26. The method of claim 25, wherein the decross-linking initiates at the outer surface and proceeds to the interior.

27. The method of claim 25, wherein the decross-linking rate increases along the vector.

28. The method of claim 25, wherein cross-links of the polymer comprise ionic cross-links.

29. The method of claim 25, wherein the cross-links comprise an organic compound, an inorganic compound, or a combination thereof.

30. The method of claim 25, wherein the cross-links comprise ionic cross-linked formed by an organic compound comprising two or more amine groups.

31. The method of claim 25, wherein the cross-links comprise a multi-functional amine, wherein a multifunctional amine is defined as a cross-linker having a number of amine groups per molecule which is greater than or equal to two, and wherein the amine is defined as NR₁R₂R₃, wherein each R can be H or another organic functional group.

32. The method of claim 28, 28-29, wherein the ionic cross-links comprise one or more of Ca²⁺, Co²⁺, Zn²⁺, Cu²⁺, Mg²⁺, Ag²⁺, Ni²⁺, Ba²⁺, Pb²⁺, Sr²⁺, Cd²⁺, Fe²⁺, Fe³′, Mn⁺⁴, and V⁺⁵.

33. The method of claim 25, wherein the decross-linking comprises contacting the article with a salt solution comprised mostly of monovalent cations.

34. The method of claim 33, wherein the decross-linking comprises contacting the article or composition with the solution for about 1 s to about 5 s, about 5 s to about 10 s, about 10 s to about 60 s, about 60 s to about 5 min, about 5 min to about 10 min, about 10 min to about 60 min, about 60 min to about 3 hr, about 3 hr to about 12 hr, about 12 hr to about 24 hr, about 24 hr to about 3 days, or about more than 3 days.
